(19) United States
(12) Patent Application Publication
(10) Pub. No.: US 2025/0097883 A1
(43) Pub. Date: Mar. 20, 2025

(54) METHOD AND DEVICE FOR CONTROLLING POSITIONING REFERENCE SIGNAL CONFIGURATION IN WIRELESS COMMUNICATION SYSTEM

(71) Applicant: SAMSUNG ELECTRONICS CO., LTD., Suwon-si (KR)

(72) Inventors: Taeseop LEE, Suwon-si (KR); Beomsik BAE, Suwon-si (KR); Seungri JIN, Suwon-si (KR); June HWANG, Suwon-si (KR)

(21) Appl. No.: 18/885,365

(22) Filed: Sep. 13, 2024

(30) Foreign Application Priority Data
Sep. 15, 2023 (KR) 10-2023-0123161

(51) Int. Cl. H04W 64/00; H04L 5/00

(52) U.S. Cl. CPC H04W 64/00; H04L 5/0051

(57) ABSTRACT

The disclosure relates to a 5G or 6G communication system for supporting a higher data transmission rate. A method of a UE in a wireless communication system is provided. The method of the UE comprises: receiving, from a network entity including a location management function (LMF), pre-defined positioning reference signal (PRS) configuration information; transmitting, to the network entity, a request for an on-demand PRS, wherein the request for the on-demand PRS includes periodicity information associated with a subcarrier spacing (SCS) of a synchronization signal block (SSB); and in response to transmitting the request for the on-demand PRS, receiving, from the network entity, PRS configuration information.

### CROSS-REFERENCE TO RELATED APPLICATION

This application is based on and claims priority under 35 U.S.C. § 119 to Korean Patent Application No. 10-2023-0123161 filed on Sep. 15, 2023, in the Korean Intellectual Property Office, the disclosure of which is incorporated by reference herein in its entirety.

### BACKGROUND

### 1. Field

The disclosure relates to an operation of a terminal, base station, and network function in a mobile communication system. More specifically, the disclosure relates to a method and device for controlling a positioning reference signal (PRS) configuration transmitted by a network for positioning of a terminal in a mobile communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure provides a device and method that can effectively provide a positioning service in a next-generation wireless communication system based on the above-described discussion.

Technical problems to be achieved in embodiments of the disclosure are not limited to the above-described technical problems, and other technical problems not described will be clearly understood by those of ordinary skill in the art to which the disclosure belongs from the description below.

A method performed by an entity that performs a location management function (LMF) in a wireless communication system for solving the above problems may include receiving, from a terminal, an auxiliary information request message including information on a transmission period of a positioning reference signal; determining positioning reference signal configuration information based on information on a transmission period of the positioning reference signal; and transmitting a reference signal configuration request message including the determined positioning reference signal configuration information.

According to an embodiment of the disclosure, a service for positioning can be effectively provided in a next-generation wireless communication system.

Effects that can be obtained from the disclosure are not limited to effects described in various embodiments, and other effects not described will be clearly understood by those of ordinary skill in the art to which the disclosure belongs from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates a structure of a NR system according to an embodiment of the disclosure;

FIG. 1B illustrates a wireless protocol structure in an LTE and NR system according to an embodiment of the disclosure;

FIG. 1C illustrates a network structure for providing an LCS in a next-generation mobile communication system according to an embodiment of the disclosure;

FIG. 1D illustrates a message flow of a process for performing an LCS in a next-generation mobile communication system according to an embodiment of the disclosure;

FIG. 1E illustrates a message flow of a process for performing procedures necessary for positioning with a terminal according to an embodiment of the disclosure;

FIG. 1F illustrates a message of a process for changing a transmission configuration of a PRS according to an embodiment of the disclosure;

FIG. 2 illustrates a structure of a terminal according to an embodiment of the disclosure;

FIG. 3 illustrates a structure of a base station according to an embodiment of the disclosure; and

FIG. 4 illustrates a structure of an NF according to an embodiment of the disclosure.

### DETAILED DESCRIPTION

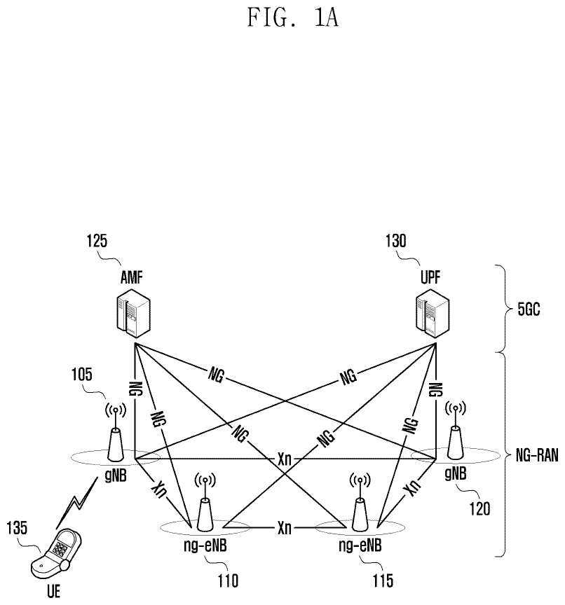

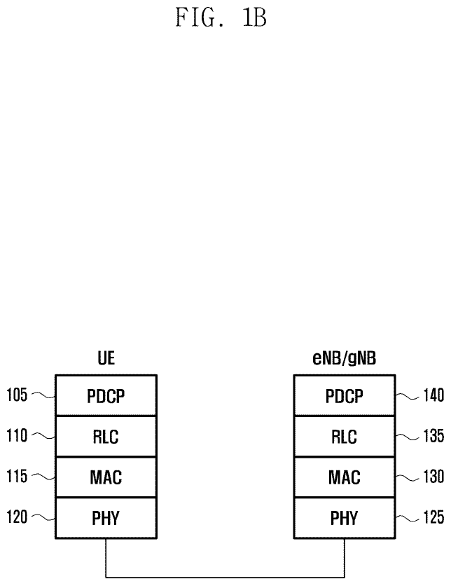

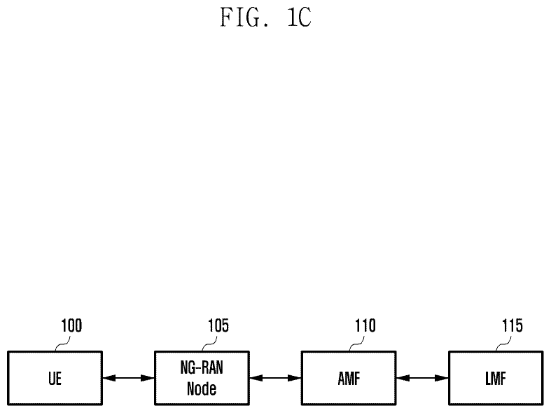

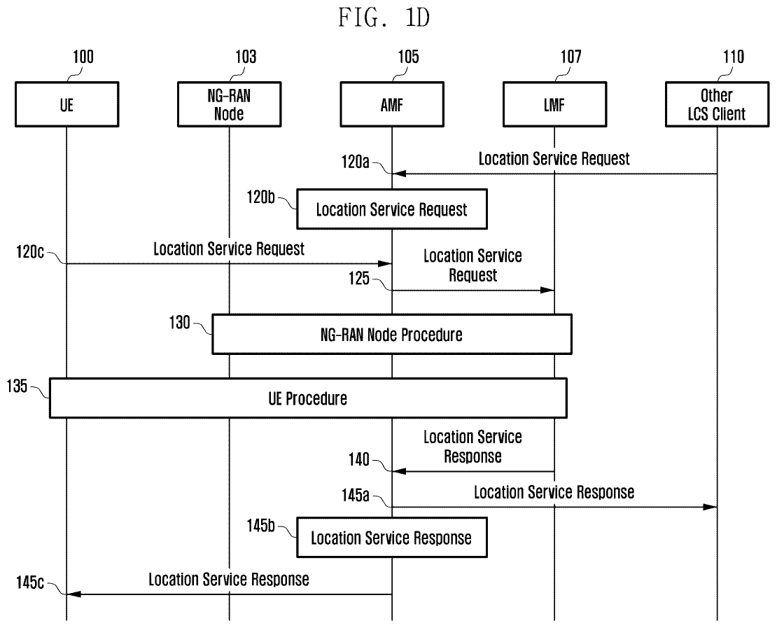

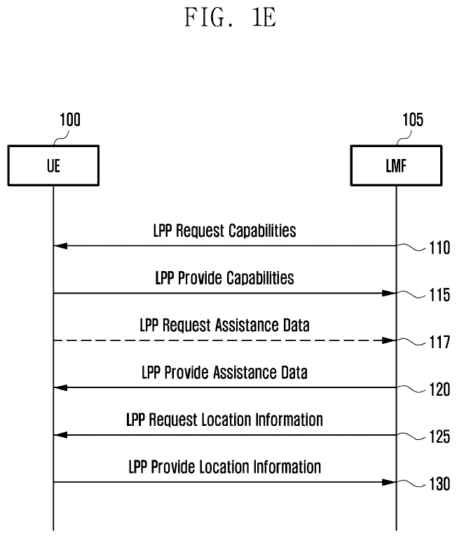

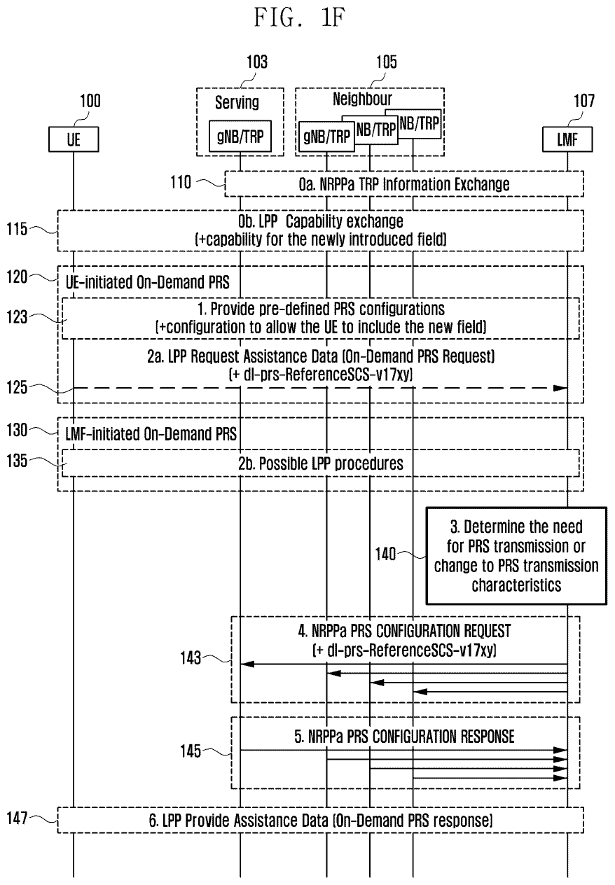

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the attached drawings. Further, in describing the disclosure, in the case that it is determined that a detailed description of a related well-known function or constitution may unnecessarily obscure the gist of the disclosure, a detailed description thereof will be omitted. Terms described below are terms defined in consideration of functions in the disclosure, which may vary according to intentions or customs of users and operators. Therefore, the definition should be made based on the content throughout this specification.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only embodiments of the disclosure enable the disclosure to be complete, and are provided to fully inform the scope of the disclosure to those of ordinary skill in the art to which the disclosure belongs, and the disclosure is only defined by the scope of the claims. Like reference numerals refer to like components throughout the specification.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the message flow diagram block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term “-unit” used in this embodiment means software or hardware components such as a field programmable gate array (FPGA) or an application specific integrated circuit (ASIC), and “-unit” performs certain roles. However, “-unit” is not limited to software or hardware. “-unit” may be formed to reside in an addressable storage medium or may be formed to reproduce one or more processors. Therefore, as an example, “-unit” includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and “-units” may be combined into a smaller number of components and “-units” or may be further separated into additional components and “-units.” Further, components and “-units” may be implemented to reproduce one or more CPUs in a device or secure multimedia card. Further, in an embodiment, “-unit” may include one or more processors.

In the following description, in describing the disclosure, in the case that it is determined that a detailed description of a related well-known function or constitution may unnecessarily obscure the gist of the disclosure, a detailed description thereof will be omitted. Hereinafter, an embodiment of the disclosure will be described with reference to the accompanying drawings.

Hereinafter, a term identifying an access node used in the description, a term indicating network entities, a term indicating messages, a term indicating an interface between network objects, a term indicating various identification information and the like are exemplified for convenience of description. Accordingly, the disclosure is not limited to the terms described below, and other terms indicating an object having an equivalent technical meaning may be used.

In the following description, a physical channel and signal may be used interchangeably with data or control signal. For example, a physical downlink shared channel (PDSCH) is a term indicating a physical channel through which data is transmitted, but the PDSCH may be used for indicating data. That is, in the disclosure, the expression “transmit a physical channel” may be interpreted equivalently to the expression “transmit data or a signal through a physical channel.”

Hereinafter, in the disclosure, higher layer signaling refers to a signal transmission method in which a signal is transmitted from a base station to a terminal using a downlink data channel of a physical layer, or from a terminal to a base station using an uplink data channel of a physical layer. Higher layer signaling may be understood as radio resource control (RRC) signaling or media access control (MAC) control element (CE).

Hereinafter, for convenience of description, the disclosure uses terms and names defined in the 3rd generation partnership project new radio (NR) (3GPP NR) or 3rd generation partnership project long term evolution (3GPP LTE) specifications. However, the disclosure is not limited by the above terms and names, and may be equally applied to systems complying with other standards. In this disclosure, for convenience of description, a gNB may be used interchangeably with an eNB. That is, a base station described as an eNB may represent a gNB. Further, the term terminal may refer to other wireless communication devices as well as a mobile phone, MTC device, NB-IoT device, sensor.

Hereinafter, a base station is a subject performing resource allocation of a terminal, and may be at least one of a gNode B (gNB), an eNode B (eNB), a node B, a base station (BS), a radio access unit, a base station controller, or a node on a network. The terminal may include a user equipment (UE), a mobile station (MS), a cellular phone, a smart phone, a computer, or a multimedia system capable of performing a communication function. The disclosure is not limited to the above examples.

FIG. 1A illustrates a structure of a new radio (NR) system according to an embodiment of the disclosure.

With reference to FIG. 1A, a wireless communication system may include several base stations (e.g., gNB 105, ng-eNB 110, ng-eNB 115, gNB 120), an access and mobility management function (AMF) 125, and a user plane function (UPF) 130.

A user equipment (hereinafter, UE or terminal) 135 may access to an external network through base stations (e.g., gNB 105, ng-eNB 110, ng-eNB 115, gNB 120) and the UPF 130.

In FIG. 1A, the base stations (e.g., gNB 105, ng-eNB 110, ng-eNB 115, and gNB 120) are access nodes of a cellular network and may provide wireless access to UEs accessing the network. That is, the base stations (e.g., gNB 105, ng-eNB 110, ng-eNB 115, and gNB 120) collect and schedule status information such as a buffer status, available transmission power status, and channel status of UEs to support connections between the UEs and the core network (CN, in particular, the CN of NR is referred to as 5GC) in order to service traffic of users.

In communication, a user plane (UP) related to transmission of actual user data and a control plane (CP) such as connection management may be divided, and in this figure, the gNB 105 and the gNB 120 uses UP and CP technologies defined in NR technology, and the ng-eNB 110 and the ng-eNB 115 may be connected to 5GC, but use UP and CP technologies defined in LTE technology.

The AMF 125 is a device responsible for various control functions as well as mobility management functions for the UE and is connected to multiple base stations, and the UPF 130 may mean a type of gateway device that provides data transmission.

Although not illustrated in FIG. 1A, the NR wireless communication system may include a session management function (SMF). The SMF may manage packet data network connections such as protocol data unit (PDU) sessions provided to the UE.

FIG. 1B illustrates a wireless protocol structure in a long term evolution (LTE) and new radio (NR) system according to an embodiment of the disclosure.

With reference to FIG. 1B, wireless protocols of the LTE system may include packet data convergence protocols (PDCP) 105 and 140, radio link controls (RLC) 110 and 135, medium access controls (MAC) 115 and 130, and physicals (PHY) 120 and 125 in the UE and the eNB, respectively.

The PDCPs 105 and 140 are responsible for operations such as IP header compression/restoration, and the RLCs 110 and 135 may reconstitute a PDCP protocol data unit (PDU) in an appropriate size. The MACs 115 and 130 may be connected to several RLC layer devices constituted in one UE, and perform operations of multiplexing RLC PDUs into MAC PDUs and demultiplexing the RLC PDUs from the MAC PDUs.

The PHY layers 120 and 125 may channel-code and modulate upper layer data, convert the data into an OFDM symbol, and transmit the symbol through a wireless channel. The PHY layers 120 and 125 may demodulate and channel-decode OFDM symbols received through a wireless channel, and transmit them to a higher layer. Further, the physical layer uses hybrid ARQ (HARQ) for additional error correction, and a receiving UE transmits with 1 bit whether a packet sent from a transmitting UE has been received. This is referred to as HARQ ACK/NACK information.

Downlink HARQ ACK/NACK information for uplink data transmission is transmitted through a physical hybrid-ARQ indicator channel (PHICH) physical channel in the case of LTE. In the case of NR, it is possible to determine whether retransmission is necessary or whether new transmission may be performed through scheduling information of the corresponding UE in a physically dedicated control channel (PDCCH), which is a channel through which downlink/uplink resource allocation is transmitted. This is because asynchronous HARQ is applied in NR.

Uplink HARQ ACK/NACK information for downlink data transmission may be transmitted through a physical uplink control channel (PUCCH) or physical uplink shared channel (PUSCH) physical channel. The PUCCH is generally transmitted in the uplink of the PCell to be described later, but in the case that the UE supports, the PUCCH may be transmitted to the corresponding UE in addition to the Scell to be described later, and this is referred to as a PUCCH SCell.

Although not illustrated in this figure, there is each radio resource control (RRC) layer over PDCP layers of the UE and the base station, and the RRC layer may transmit and receive access and measurement-related configuration control messages for radio resource control.

The PHY layer may be composed of one or a plurality of frequencies/carriers, and the technology of simultaneously configuring and using or a plurality of frequencies is referred to as carrier aggregation (hereinafter, referred to as CA). CA technology may dramatically increase the transmission capacity by the number of secondary carriers by additionally using a main carrier and one or a plurality of secondary carriers, rather than using only one carrier for communication between a user equipment (or UE) and an E-UTRAN NodeB (eNB)). In LTE, a cell within a base station using a main carrier is referred to as a main cell or a primary cell (PCell), and a cell within a base station using a subcarrier is referred to as a sub-cell or a secondary cell (SCell).

FIG. 1C illustrates a network structure for providing a location service (LCS) in a next-generation mobile communication system according to an embodiment of the disclosure.

With reference to FIG. 1C, a network for providing an LCS in the next-generation mobile communication system may include a user equipment (UE) 100, an NG-RAN node 105, an access and mobility function (AMF) 110, and a location management function (LMF) 115. In this case, the UE 100 may communicate with the LMF 115 through the NG-RAN node 105 and the AMF 110, and transmit and receive information necessary for positioning. The role of each component for providing an LCS is as follows.

The UE 100 may measure radio signals necessary for positioning and transmit measurement results to the LMF 115.

The NG-RAN node 105 may perform roles such as transmitting downlink radio signals necessary for positioning and measuring uplink radio signals transmitted by a target UE.

The AMF 110 may receive an LCS request message from an LCS requester and then transmit the LCS request message to the LMF 115 to indicate provision of a location providing service. When the LMF 115 processes a positioning request and responds the positioning result of the UE, the AMF 110 may transmit the result to the LCS requester.

The LMF 115 is a device that receives and processes the LCS request from the AMF 110, and may perform the role of controlling the overall process required for positioning.

For positioning of the UE, the LMF 115 may provide auxiliary information necessary for positioning and signal measurement to the UE 100 and receive a result value thereof, and in this case, an LTE positioning protocol (LPP) may be used as a protocol for data exchange. The LPP may define message specifications exchanged between the UE 100 and the LMF 115 for the positioning service.

Further, the LMF 115 may exchange positioning reference signal (PRS) configuration information and sounding reference signal (SRS) measurement results to be used for positioning with the NG-RAN node 105. In this case, an NR positioning protocol A (NRPPa) may be used as a protocol for data exchange, and NRPPa may define message specifications exchanged between the NG-RAN node 105 and the LMF 115.

FIG. 1D illustrates a message flow of a process for performing a location service (LCS) in a next-generation mobile communication system according to an embodiment of the disclosure.

With reference to FIG. 1D, the AMF 105 may receive an LCS request 120a/b/c and then transmit the LCS request to the LMF 107. Thereafter, the LMF 107 may control a process of exchanging necessary information with the UE and the base station so as to process the LCS request 120a/b/c and transmit a result value (positioning result) thereof to the AMF 105. The AMF 105 may transmit the result value to a target requested an LCS to complete to perform the LCS.

In step 120, the AMF 105 may acquire an LCS request.

More specifically, there are three types of LCS request that the AMF 105 receives in step 120:
1. LCS Request 120a received from an external LCS client 110;
2. LCS Request 120b generated by the AMF 105 itself, and
3. LCS Request 120c received from the UE 100.

The AMF 105 does not necessarily obtain the LCS request through steps 120a, 120b, and 120c, but may acquire the LCS request through any one of steps 120a, 120b, or 120c.

The LCS request may include at least one of an ID of the LCS target UE or LCS quality of service (QoS) request information. For example, LCS QoS request information may include requirements for positioning accuracy and latency. In step 125, the AMF 105 may transmit a location service request message to the LMF 107. More specifically, after receiving one of three types of LCS requests, the AMF 105 may transmit a location service request message to the LMF 107 to request to provide a positioning service.

Thereafter, in step 130, the LMF 107 may perform procedures necessary for positioning with the base station (NG-RAN Node Procedure).

More specifically, the LMF 107 may proceed procedures necessary for positioning (e.g., base station PRS configuration, base station SRS measurement information acquisition, and the like) through exchange of NRPPa messages with the NG-RAN Node 103.

Further, in step 135, the LMF 107 may perform procedures necessary for positioning with the UE (UE procedure).

More specifically, the LMF 107 may exchange LPP messages so as to exchange necessary information with the UE 100. Through the above process, the LMF 107 may proceed procedures such as UE capability information exchange related to positioning, auxiliary information transfer for signal measurement of the UE, and UE measurement result request and acquisition.

In step 140, the LMF 107 may transmit a location service response message to the AMF 105.

More specifically, when the LMF 107 determines positioning of the UE based on acquired various measurement results, the LMF 107 may transmit a location service response message 140 to the AMF 105.

In step 145, the AMF 105 may transmit a location service response message.

More specifically, the AMF 105 may transmit an LCS response message 145a/b/c to a target requested an LCS, and the LCS response message 145a/b/c may include UE positioning results.

For example, in the case that the AMF 105 receives an LCS request from the external LCS Client 110 (step 120a), the AMF 105 may transmit a location service response message to the external LCS client 110 (step 145a).

For example, in the case that the AMF 105 itself generates an LCS request (step 120b), the AMF 105 itself may acquire a location service response message (step 145b).

For example, in the case that the AMF 105 receives an LCS request from the UE 100 (step 120c), the AMF 105 may transmit a location service response message to the UE 100 (step 145c).

FIG. 1E illustrates a message flow of a process for performing procedures necessary for positioning with a UE according to an embodiment of the disclosure.

More specifically, FIG. 1E is a message flow diagram illustrating a detailed LTE positioning protocol (LPP) message exchange process in the UE procedure step 135 in FIG. 1D. FIG. 1E illustrates a process in which the LMF 105 performs procedures such as UE capability information exchange related to positioning with the UE 100, auxiliary information transfer for signal measurement of the UE, UE measurement result request and acquisition, and the like. The use and definition of each LPP message exchanged at each step are as follows.

—LPP Request Capabilities (LMF→UE 110):

The LMF 105 may use LPP request capabilities in order to request UE capability information related to positioning to the UE 100. Information included in the request capabilities message may be defined as in Table 1. A request for common information regardless of a positioning method (e.g., global navigation satellite system (GNSS), observed time difference of arrival (OTDOA), enhance cell TD (ECID), and the like) may be included in CommonIEsRequestCapabilities, and an additional information request required for each positioning method may be included in a separate information element (JE) for each method.

TABLE 1
RequestCapabilities ::= SEQUENCE {

| criticalExtensions | | CHOICE { |
|---|---|---|
| | cl | CHOICE { |
| | requestCapabilities-r9 | RequestCapabilities-r9-IEs, |
| | spare3 NULL, spare2 NULL, spare1 NULL | |
| | }, | |
| | criticalExtensionsFuture | SEQUENCE { } |

]
}
RequestCapabilities-r9-IEs ::= SEQUENCE {

| | | | |
|---|---|---|---|
| commonIEsRequestCapabilities | CommonIEsRequestCapabilities | OPTIONAL, | -- Need ON |
| a-gnss-RequestCapabilities | A-GNSS-RequestCapabilities | OPTIONAL, | -- Need ON |
| otdoa-RequestCapabilities | OTDOA-RequestCapabilities | OPTIONAL, | -- Need ON |
| ecid-RequestCapabilities | ECID-RequestCapabilities | OPTIONAL, | -- Need ON |
| epdu-RequestCapabilities | EPDU-Sequence | OPTIONAL, | -- Need ON |

...,

| | | | | |
|---|---|---|---|---|
| [[ | sensor-RequestCapabilities-r13 | Sensor-RequestCapabilities-r13 | OPTIONAL, | -- Need ON |
| | tbs-RequestCapabilities-r13 | TBS -RequestCapabilities-r13 | OPTIONAL, | -- Need ON |
| | wlan-RequestCapabilities-r13 | WLAN-RequestCapabilities-r13 | OPTIONAL, | -- Need ON |
| | bt-RequestCapabilities-r13 | BT-RequestCapabilities-r13 | OPTIONAL | -- Need ON |

]],

| [[ | nr-ECID-RequestCapabilities-r16 | NR-ECID-RequestCapabilities-r16 | OPTIONAL, | -- Need ON |
|---|---|---|---|---|
| | nr-Multi-RTT-RequestCapabilities-r16 | | | |
| | | NR-Multi-RTT-RequestCapabilities-r16 | | |
| | | | OPTIONAL, | -- Need ON |
| | nr-DL-AoD-RequestCapabilities-r16 | | | |
| | | NR-DL-AoD-RequestCapabilities-r16 | OPTIONAL, | -- Need ON |
| | nr-DL-TDOA-RequestCapabilities-r16 | | | |
| | | NR-DL-TDOA-RequestCapabilities-r16 | OPTIONAL, | -- Need ON |
| | nr-UL-RequestCapabilities-r16 | NR-UL-RequestCapabilities-r16 | OPTIONAL | -- Need ON |

]]
}

—LPP Provide Capabilities (UE→LMF, 115):

The UE 100 may use LPP provide capabilities in order to transmit UL capability information requested from the LMF 105. Information included in the Provide Capabilities message may be defined as in Table 2. Similar to the LPP request capabilities message, common information regardless of the positioning method (e.g., GNSS, OTDOA, ECID, and the like) may be included in commonIEsProvideCapabilities, and information requested for each positioning method may be included in separate IEs.

TABLE 2
ProvideCapabilities ::= SEQUENCE {

| criticalExtensions | | CHOICE { |
|---|---|---|
| | cl | CHOICE { |
| | provideCapabilities-r9 | ProvideCapabilities-r9-IEs, |
| | spare3 NULL, spare2 NULL, spare1 NULL | |
| | }, | |
| | criticalExtensionsFuture | SEQUENCE { } |

}
}
ProvideCapabilities-r9-IEs ::= SEQUENCE {

| | | |
|---|---|---|
| commonIEsProvideCapabilities | CommonIEsProvideCapabilities | OPTIONAL, |
| a-gnss-ProvideCapabilities | A-GNSS-ProvideCapabilities | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |

...,

| | | | |
|---|---|---|---|
| [[ | sensor-ProvideCapabilities-r13 | Sensor-ProvideCapabilities-r13 | OPTIONAL, |
| | tbs-ProvideCapabilities-r13 | TBS-ProvideCapabilities-r13 | OPTIONAL, |
| | wlan-ProvideCapabilities-r13 | WLAN-ProvideCapabilities-13 | OPTIONAL, |
| | bt-ProvideCapabilities-r13 | BT-ProvideCapabilities-r13 | OPTIONAL |

]],

| [[ | nr-ECID-ProvideCapabilities-r16 | NR-ECID-ProvideCapabilities-r16 | OPTIONAL, |
|---|---|---|---|
| | nr-Multi-RTT-ProvideCapabilities-r16 | | |
| | | NR-Multi-RTT-ProvideCapabilities-r16 | OPTIONAL, |
| | nr-DL-AoD-ProvideCapabilities-r16 | | |
| | | NR-DL-AoD-ProvideCapabilities-r16 | OPTIONAL, |
| | nr-DL-TDOA-ProvideCapabilities-r16 | | |
| | | NR-DL-TDOA-ProvideCapabilities-r16 | OPTIONAL, |
| | nr-UL-ProvideCapabilities-r16 | NR-UL-ProvideCapabilities-r16 | OPTIONAL |

]]
}

—LPP requestAssistanceData (UE→LMF, 117):

The UE 100 may use LPP requestAssistanceData in order to request information necessary or helpful for measuring wireless signals for positioning to the LMF 105. Information included in the requestAssistanceData message may be defined as in Table 3. Common information regardless of the positioning method (e.g., GNSS, OTDOA, ECID, and the like) may be included in commonIEsRequestAssistanceData, and information requested for each positioning method may be included in separate JEs.

TABLE 3
RequestAssistanceData ::= SEQUENCE {

| criticalExtensions | | CHOICE { |
|---|---|---|
| | cl | CHOICE { |
| | requestAssistanceData-r9 | RequestAssistanceData-r9-IEs, |
| | spare3 NULL, spare2 NULL, spare1 NULL | |
| | }, | |
| | criticalExtensionsFuture | SEQUENCE { } |

}
}
RequestAssistanceData-r9-IEs ::= SEQUENCE {

| | | |
|---|---|---|
| commonIEsRequestAssistanceData | CommonIEsRequestAssistanceData | OPTIONAL, |
| a-gnss-RequestAssistanceData | A-GNSS-RequestAssistanceData | OPTIONAL, |
| otdoa-RequestAssistanceData | OTDOA-RequestAssistanceData | OPTIONAL, |
| epdu-RequestAssistanceData | EPDU-Sequence | OPTIONAL, |

...,

| [[ | sensor-RequestAssistanceData-r14 | | |
|---|---|---|---|
| | | Sensor-RequestAssistanceData-r14 | OPTIONAL, |
| | tbs-RequestAssistanceData-r14TBS-RequestAssistanceData-r14 | | OPTIONAL, |
| | wlan-RequestAssistanceData-r14 | WLAN-RequestAssistancebata-r14 | OPTIONAL, |

]],

| | | | |
|---|---|---|---|
| [[ | nr-Multi-RTT-RequestAssistanceData-r16 | NR-Multi-RTT-RequestAssistanceData-r16 | OPTIONAL, |
| | nr-DL-AoD-RequestAssistanceData-r16 | NR-DL-AoD-RequestAssistanceData-r16 | OPTIONAL, |
| | nr-DL-TDOA-RequestAssistanceData-rl6 | NR-DL-TDOA-RequestAssistanceData-r16 | OPTIONAL |

]]
}

—LPP ProvideAssistanceData (LMF→UE, 120):

The LMF 105 may use LPP ProvideAssistanceData in order to provide information necessary or helpful for measuring wireless signals for positioning of the UE 100. Information included in the ProvideAssistanceData message may be defined as in Table 4. Common information regardless of the positioning method (e.g., GNSS, OTDOA, ECID, and the like) may be included in commonIEsProvideAssistanceData, and information provided for each positioning method may be included in separate IEs.

TABLE 4
ProvideAssistanceData ::= SEQUENCE {

| criticalExtensions | | CHOICE { |
|---|---|---|
| | cl | CHOICE { |
| | provideAssistanceData-r9 | ProvideAssistanceData-r9-IEs, |
| | spare3 NULL, spare2 NULL, spare1 NULL | |
| | }, | |
| | criticalExtensionsFuture | SEQUENCE { } |

}
}
ProvideAssistanceData-r9-IEs :: = SEQUENCE {

| | | | |
|---|---|---|---|
| commonIEsProvideAssistanceData | CommonIEsProvideAssistanceData | OPTIONAL, | -- Need ON |
| a-gnss-ProvideAssistanceData | A-GNSS-ProvideAssistanceData | OPTIONAL, | -- Need ON |
| otdoa-ProvideAssistanceData | OTDOA-ProvideAssistanceData | OPTIONAL, | -- Need ON |
| epdu-Provide-Assistance-Data | EPDU-Sequence | OPTIONAL, | -- Need ON |

```
  ...,
  [[
```

| | | | |
|---|---|---|---|
| sensor-ProvideAssistanceData-r14 | Sensor-ProvideAssistanceData-r14 | OPTIONAL, | -- Need ON |
| tbs-ProvideAssistanceData-r14 | TBS-ProvideAssistanceData-r14 | OPTIONAL, | -- Need ON |
| wlan-ProvideAssistanceData-r14 | WLAN-ProvideAssistanceData-r14 | OPTIONAL, | -- Need ON |

]],

| | |
|---|---|
| [[ | nr-Multi-RTT-ProvideAssistanceData-r16 |

NR-Multi-RTT-ProvideAssistanceData-r16

| | |
|---|---|
| OPTIONAL, | -- Need ON |

nr-DL-AoD-ProvideAssistanceData-r16

| | | |
|---|---|---|
| NR-DL-AoD-ProvideAssistanceData-r16 | OPTIONAL, | -- Need ON |

nr-DL-TDOA-ProvideAssistanceData-r16

NR-DL-TDOA-ProvideAssistanceData-r16

| | |
|---|---|
| OPTIONAL | -- Need ON |

]]
}

LPP Request Location Information (LMF→UE, 125):

The LMF 105 may use LPP request location information in order to request signal measurement and positioning results necessary for positioning to the UE 100. The LMF 105 may determine which positioning method to use, what measurements the UE may perform for this purpose, what results and how to respond, and then include relevant information in this message and transmit the message to the UE 100. Information included in the request location information message may be defined as in Table 5.

TABLE 5
RequestLocationInformation ::= SEQUENCE {

| criticalExtensions | | CHOICE { |
|---|---|---|
| | cl | CHOICE { |
| | requestLocationInformation-r9 | RequestLocationInformation-r9-IEs, |
| | spare3 NULL, spare2 NULL, spare1 NULL | |
| | }, | |
| | criticalExtensionsFuture | SEQUENCE { } |

```
  }
}
RequestLocationInformation-r9-IEs ::= SEQUENCE {
  commonIEsRequestLocationInformation
```

| | CommonIEsRequestLocationInformation | OPTIONAL, | -- Need ON |
|---|---|---|---|
| a-gnss-RequestLocationInformation | A-GNSS-RequestLocationInformation | OPTIONAL, | -- Need ON |
| otdoa-RequestLocationInformation | OTDOA-RequestLocationInformation | OPTIONAL, | -- Need ON |
| ecid-RequestLocationInformation | ECID-RequestLocationInformation | OPTIONAL, | -- Need ON |
| epdu-RequestLocationInformation | EPDU-Sequence | OPTIONAL, | -- Need ON |

```
  ...,
  [[
  sensor-RequestLocationInformation-r13
```

| | Sensor-RequestLocationInformation-r13 | | |
|---|---|---|---|
| | | OPTIONAL, | -- Need ON |
| tbs-RequestLocationInformation-r13 | TBS-RequestLocationInformation-r13 | OPTIONAL, | -- Need ON |
| wlan-RequestLocationInformation-r13 | WLAN-RequestLocationInformation-r13 | OPTIONAL, | -- Need ON |
| bt-RequestLocationInformation-r13 | BT-RequestLocationInformation-r13 | OPTIONAL | -- Need ON |

]],

| | |
|---|---|
| [[ | nr-ECID-RequestLocationInformation-r16 |

NR-ECID-RequestLocationInformation-r16

| | |
|---|---|
| OPTIONAL, | -- Need ON |

nr-Multi-RTT-RequestLocationInformation-r16

NR-Multi-RTT-RequestLocationInformation-r16

| | |
|---|---|
| OPTIONAL, | -- Need ON |

nr-DL-AoD-RequestLocationInformation-r16

NR-DL-AoD-RequestLocationInformation-r16

| | |
|---|---|
| OPTIONAL, | -- Need ON |

nr-DL-TDOA-RequestLocationInformation-r16

NR-DL-TDOA-RequestLocationInformation-r16

| | |
|---|---|
| OPTIONAL | -- Need ON |

]]
}

—LPP Provide Location Information (UE→LMF, 130): The UE 100 may use LPP provide location information in order to transmit measurement results and positioning results requested from the LMF 105 to the LMF 105. Information included in the provide location information message may be defined as in Table 6.

TABLE 6
ProvideLocationInformation ::= SEQUENCE {

| criticalExtensions | | CHOICE { |
|---|---|---|
| | cl | CHOICE { |
| | provideLocationInformation-r9 | ProvideLocationInformation-r9-IEs, |
| | spare3 NULL, spare2 NULL, spare1 NULL | |
| | }, | |
| | criticalExtensionsFuture | SEQUENCE { } |

```
  }
}
ProvideLocationInformation-r9-IEs ::= SEQUENCE {
  commonIEsProvideLocationInformation
```

| | CommonIEsProvideLocationInformation | OPTIONAL, |
|---|---|---|
| a-gnss-ProvideLocationInformation | A-GNSS-ProvideLocationInformation | OPTIONAL, |
| otdoa-ProvideLocationInformation | OTDOA-ProvideLocationInformation | OPTIONAL, |
| ecid-ProvideLocationInformation | ECID-ProvideLocationInformation | OPTIONAL, |
| epdu-ProvideLocationInformation | EPDU-Sequence | OPTIONAL, |

```
  ...,
  [[
  sensor-ProvideLocationInformation-r13
```

| | Sensor-ProvideLocationInformation-r13 | |
|---|---|---|
| | | OPTIONAL, |
| tbs-ProvideLocationInformation-r13 | TBS-ProvideLocationInformation-r13 | OPTIONAL, |
| wlan-ProvideLocationInformation-r13 | WLAN-ProvideLocationInformation-r13 | OPTIONAL, |
| bt-ProvideLocationInformation-r13 | BT-ProvideLocationInformation-r13 | OPTIONAL |

]],

| | |
|---|---|
| [[ | nr-ECID-ProvideLocationInformation-r16 |

| | |
|---|---|
| NR-ECID-ProvideLocationInformation-r16 | OPTIONAL, |

nr-Multi-RTT-ProvideLocationInformation-r16

| | |
|---|---|
| NR-Multi-RTT-ProvideLocationInformation-r16 | OPTIONAL, |

nr-DL-AoD-ProvideLocationInformation-r16

| | |
|---|---|
| NR-DL-AoD-ProvideLocationInformation-r16 | OPTIONAL, |

nr-DL-TDOA-ProvideLocationInformation-r16

| | |
|---|---|
| NR-DL-TDOA-ProvideLocationInformation-r16 | OPTIONAL |

]]
}

FIG. 1F illustrates a message flow of a process for changing a transmission configuration of a positioning reference signal (PRS) according to an embodiment of the disclosure.

More specifically, FIG. 1F is a message flow diagram illustrating a process in which a network changes a DL-PRS transmission configuration based on requirements for a downlink reference signal DL-PRS configuration to be used for positioning of the UE.

With reference to FIG. 1F, the gNB/TRP 103 and 105 receive requirements for a DL-PRS configuration from the UE and the LMF through an on-demand PRS procedure started (or initiated) from the UE 100 or the LMF 107, and create and change the DL-PRS transmission configuration based on the requirements.

According to an embodiment of the disclosure, the UE 100 or the LMF may request the base station to change the DL-PRS transmission configuration in order to increase positioning accuracy of the UE or to reduce latency. For example, in the case that because a current DL-PRS transmission period of the base station is long, the time it takes for the UE to perform DL-PRS measurement necessary for positioning is too long or there are restrictions on positioning accuracy that may be acquired within a determine time, the UE or the LMF may request a shorter DL-PRS transmission period to the base station. An on-demand PRS procedure in which the UE or LMF requests the base station to change a DL-PRS transmission configuration for positioning of the UE may be described in each step as follows.

In step 110, the LMF 107 may perform a TRP information exchange procedure. (0a. NRPPa (TRP information exchange).

More specifically, the LMF 107 may receive information related to an on-demand PRS configuration that the base station may support through a TRP information exchange procedure.

In step 115, the LMF 107 may perform a UE capability exchange procedure with the UE 100. (Ob. LPP capability exchange).

More specifically, the UE 100 and the LMF 107 may exchange UE capability information related to the on-demand PRS procedure through a capability exchange procedure. The UE capability information may include information related to whether the UE 100 may request a specific configuration value for the required DL-PRS configuration when transmitting the requirement for DL-PRS to the LMF through an LPP request assistance data (on-demand PRS request) message in step 120 (UE-initiated on-demand PRS), and information related to whether the request may be made in the form of a list of pre-defined PRS configuration index values provided by the LMF.

Further, the UE capability information may include new UE capability information indicating whether the UE supports a new field in the case that the UE defines the new field in order to provide additional information (e.g., dl-prs-ReferenceSCS-v17xy, dl-prs-SCS-Req-v17xy, dl-prs-ResourceSetPeriodicityReq2-v17xy) to the LMF in step 125 (capability for the newly introduced field). Specific details will be described later.

Thereafter, the on-demand PRS procedure may be initiated. The on-demand PRS procedure may be initiated by the UE 100 (step 120), the LMF 107 (step 130), or both the UE 100 and the LMF 120.

In step 120, specific details of initiating the on-demand PRS procedure by the UE may include any one or more of steps 123 and 125. (UE-initiated on-demand PRS)

In step 123, the LMF 107 may provide a predetermined PRS configuration (or configuration information) to the UE 100. (Provide pre-defined PRS configurations)

More specifically, in the case of a UE-initiated on-demand PRS 120, the LMF 107 may provide a pre-defined PRS configuration (or configuration information) to the UE 100 through an LPP provide assistance data message. One or more DL-PRS configuration information may be provided to the UE along with a separate DL-PRS-Configuration-ID value.

Further, the provide assistance data message may include information (or an indicator) indicating whether the UE 100 may use a new field in the case that the new field (e.g., dl-prs-ReferenceSCS-v17xy, dl-prs-SCS-Req-v17xy, dl-prs-ResourceSetPeriodicityReq2-v17xy) is defined in order for the UE to provide additional information to the LMF in step 125 (configuration to allow the UE to include the new field). Specific details will be described later.

In step 125, the UE 100 may transmit a request assistance data message to the LMF 107 (LPP request assistance data (on-demand PRS Request)).

More specifically, in the case of a UE-initiated on-demand PRS 120, the UE 100 may transmit an on-demand PRS request to the LMF 107 through an LPP request assistance data message. In this case, the on-demand PRS request may be a method of requesting some of the DL-PRS configuration (or configuration information) included in the pre-defined PRS configuration (or configuration information) given in step 123 in the form of a list of ID values connected with the configuration or a method of explicitly requesting specific variable values of the DL-PRS configuration (or configuration information).

For reference, requirements for the DL-PRS transmission configuration (NR-on-demand-DL-PRS-Request IE) and the DL-PRS configuration request variables are as follows.

-dl-prs-StartTime-and-Duration:

Requested DL-PRS transmission start time and transmission duration values. The start time (dl-prs-start-time) is a time from a time point that has received the NR-On-Demand-DL-PRS-Request to a DL-PRS transmission start time point and may have a value of 1 to 1024 seconds. The transmission duration (dl-prs-duration) value means a length of time in which dl-prs transmission is maintained and may have a value between 0 and 23 hours 59 minutes and 59 seconds.

-dl-prs-ResourceSetPeriodicityReq:

It is a transmission period value of the requested DL-PRS resource set. It is requested in units of a positioning frequency layer (PFL). The transmission period value may be configured in units of a slot, and the maximum number of slots that may be configured varies according to a subcarrier spacing (SCS) value used for DL-PRS transmission, but an absolute time value may be between 0 and 10.24 seconds. For reference, a DL-PRS resource set is a set of several DL-PRS resources, and DL-PRS resources included in the same DL-PRS resource set are transmitted at the same period and have the same symbol length.

A specific transmission method of the dl-prs-ResourceSetPeriodicityReq is described below.

-dl-prs-NumSymbolsReq:

It is the number of symbols of requested DL-PRS resource (number of symbols in which a DL-PRS resource is transmitted). It is requested in units of a PFL. The number of symbols may have one value of 2, 4, 6, or 12.

-dl-prs-FrequencyRangeReq:

Transmission frequency band (FR1 or FR2) of the requested DL-PRS. It is requested in units of a PFL.

-dl-prs-ResourceBandwidthReq:

Bandwidth of the requested DL-PRS resource. It is requested in units of a PFL. The bandwidth value may have a value between 24PRBs and 272PRBs.

-dl-prs-ResourceRepetitionFactorReq:

Number of repetitions of requested DL-PRS resource. It is requested in units of a PFL. The number of repetitions may have one value of 2, 4, 6, 8, 16, or 32.

-dl-prs-CombSizeN-Req:

It means a resource element (RE) interval between symbols of the requested DL-PRS resource. It is requested in units of a PFL. A requested combSize value may have one value of 2, 4, 6, or 12.

In step 130, specific details of initiating the on-demand PRS procedure by the LMF may include step 135 (LMF-initiated on-demand PRS).

In step 135, the UE 100 and the LMF 107 may exchange LPP messages (Possible LPP procedures).

More specifically, in the case of an LMF-initiated on-demand PRS 130, the UE 100 and the LMF 107 may exchange LPP messages (e.g., LPP request capabilities, LPP provide capabilities, LPP request assistance data, LPP provide assistance data, LCC request location information, LPP provide location information) necessary for positioning of the UE, as illustrated in the FIG. 1E. In this way, while the LMF 107 is performing positioning of a specific UE through an LPP signaling procedure, the LMF 107 may determine that the DL-PRS transmission configuration of the base station needs to be changed (or new configuration) for positioning of the UE as in step 140.

In step 140, the LMF 107 may determine that the DL-PRS transmission configuration needs to be changed (or new configuration) (determination of the need for PRS Tx or the change of PRS Tx characteristics).

More specifically, the LMF 107 may determine to change the DL-PRS configuration of the base station (or the need for new DL-PRS configuration) based on the requirement for the DL-PRS transmission configuration (NR-On-Demand-DL-PRS-Request) received from the UE in step 125 or the LPP message exchange in step 135. In this case, when the LMF 107 determines that DL-PRS configuration change or new configuration is necessary, the LMF 107 may request a DL-PRS configuration change (or DL-PRS new configuration) to the gNB/TRP 103 and 105 through an NRPPa message as in step 143.

In step 143, the LMF 107 may transmit a PRS configuration request message to at least one gNB/TRP 103 and 105. (NRPPa PRS CONFIGURATION REQUEST).

More specifically, the LMF 107 may request the gNB/TRP 103 and 105 to change a DL-PRS configuration or a new DL-PRS configuration through the NRPPa PRS CONFIGURATION REQUEST message. In the NRPPa PRS CONFIGURATION REQUEST message, requested DL-PRS configuration variables may be included as illustrated in Table 7.

TABLE 7

| | | | IE Type and | |
|---|---|---|---|---|
| IE/Group Name | Presence | Range | Reference | Semantics Description |
| Requested DL- | | 1 | | |
| PRS Resource | | | | |
| Set List | | | | |
| >Requested | | 1 | | |
| DL-PRS | | . . . <maxnoofPRSresourceSet> | | |
| Resource Set | | | | |
| Item | | | | |
| >>PRS | O | | INTEGER(1 . . . 63) | 24, 28, . . . , 272 PRBs |
| bandwidth | | | | |
| >>Comb Size | O | | ENUMERATED(2, | |
| | | | 4, 6, 12, . . . ) | |
| >>Resource Set | O | | ENUMERATED(4, | |
| Periodicity | | | 5, 8, 10, 16, 20, 32, 40, | |
| | | | 64, 80, 160, 320, 640, | |
| | | | 1280, 2560, 5120, | |
| | | | 10240, 20480, 40960, | |
| | | | 81920, . . . ) | |
| >>Resource | O | | ENUMERATED(rf1, | |
| Repetition Factor | | | rf2, rf4, rf6, rf8, rf16, | |
| | | | rf32, . . . ) | |
| >>Resource | O | | ENUMERATED | |
| Number of | | | (n2, n4, n6, n12, . . . ) | |
| Symbols | | | | |
| >>Requested DL- | O | | 9.2.62 | |
| PRS Resource List | | | | |
| >>Resource Set | O | | Start Time and | This IE is ignored if the |
| Start Time and | | | Duration9.2.63 | Start Time and Duration |
| Duration | | | | IE is present |
| Number of | O | | INTEGER(1 . . . 4) | |
| Frequency Layers | | | | |
| Start Time and | O | | 9.2.63 | |
| Duration | | | | |

More specifically, a specific meaning of each variable may be described as follows:
PRS bandwidth: bandwidth of the requested DL-PRS resource. It is requested in units of a DL-PRS resource set. A bandwidth value may have a value between 24PRBs and 272PRBs;
Comb size: It means a resource element (RE) interval between symbols of the requested DL-PRS resource. It is requested in units of a DL-PRS resource set. A requested combSize value may have any value of 2, 4, 6, or 12;
Resource set periodicity: transmission period value of the requested DL-PRS resource set. It is requested in units of a DL-PRS resource set. The transmission period value may be configured in units of a slot, and the maximum number of slots that may be configured varies according to the SCS value used for DL-PRS transmission, but an absolute time value may be between 0 and 10.24 seconds. For reference, a DL-PRS resource set is a set of several DL-PRS resources, and DL-PRS resources included in the same DL-PRS resource set are transmitted at the same period and have the same symbol length;
Resource repetition factor: it is the number of repetitions of a requested DL-PRS resource. It is requested in units of a DL-PRS resource set. The number of repetitions may have any value of 2, 4, 6, 8, 16, or 32;
Resource number of symbols: number of symbols of the requested DL-PRS resource (number of symbols in which the DL-PRS resource is transmitted). It is requested in units of a DL-PRS resource set. The number of symbols may have any value of 2, 4, 6, or 12;
Resource set start time and duration: requested DL-PRS transmission start time and transmission duration values. A start time represents a relative time value in units of 1/(2\hat{ }32) seconds based on 00:00:00 on Jan. 1, 1900, and transmission duration represents a time length in which requested DL-PRS transmission is maintained in units of a second up to maximum 90060 seconds. The start time and duration values are requested in units of a request message (requested DL PRS transmission characteristics) or DL-PRS resource set; and
Number of frequency layers: number of requested DL-PRS transmission frequency layers. They are requested in units of a request message (requested DL PRS Transmission Characteristics). They may have integer values between 1 and 4.

Further, in the PRS CONFIGURATION REQUEST message, in the case that a new field (e.g., dl-prs-ReferenceSCS-v17xy, dl-prs-SCS-Req-v17xy, dl-prs-ResourceSetPeriodicityReq2-v17xy) is defined for the UE to provide additional information to the LMF in step 125, the LMF 107 may transmit the corresponding information to the gNB/TRP 103 and 105. To this end, a new field corresponding to the new field provided in step 125 may be defined in the requested DL PRS transmission characteristics IE included in an NRPPa PRS CONFIGURATION REQUEST message. Specific details will be described later.

In step 145, at least one base station 103 and 105 may transmit a PRS configuration response message to the LMF 107 (NRPPa PRS CONFIGURATION RESPONSE).

After successfully completing a DL-PRS configuration change or a new DL-PRS configuration according to the request of the LMF 107 in step 143, the gNB/TRP 103 and 105 may transmit the updated DL-PRS configuration (or configuration information) through an NRPPa PRS CONFIGURATION RESPONSE message or a new DL-PRS configuration (or configuration information) to the LMF 107.

In step 147, the LMF 107 may transmit a provide assistance data message to the UE 100. (e.g., LPP provide assistance data (on-demand PRS response).

More specifically, the LMF 107 may provide DL-PRS configuration information received from at least one gNB/TRP 103 or 105 to the UE through an LPP provide assistance data message in step 145. In this case, the LPP provide assistance data message may be used as a response to the on-demand PRS request in step 125.

In step 125, the UE may include a DL-PRS transmission period requested in units of a positioning frequency layer (PFL) in the on-demand-DL-PRS-Request through a dl-prs-ResourceSetPeriodicityReq-r17 field. In this case, the ASN.1 code and field definition of the dl-prs-ResourceSetPeriodicityReq-r17 field are illustrated in Table 8.

TABLE 8
NR-On-Demand-DL-PRS-PerFreqLayer-r17 ::= SEQUENCE {

| dl-prs-FrequencyRangeReq-r17 | ENUMERATED { fr1, fr2, ...}, | |
|---|---|---|
| dl-prs-ResourceSetPeriodicityReq-r17 | ENUMERATED { p4, p5, p8, p10, p16, p20, p32, p40, | |
| | p64, p80, p160, p320, p640, p1280, p2560, | |
| | p5120, p10240, p20480, p40960, p81920, ...} | |
| | | OPTIONAL, |
| dl-prs-ResourceBandwidthReq-r17 | INTEGER (1..63) | OPTIONAL, |
| dl-prs-ResourceRepetitionFactorReq-r17 | ENUMERATED {n2, n4, n6, n8, n16, n32, ...} | |
| | | OPTIONAL, |
| dl-prs-NumSymbolsReq-r17 | ENUMERATED {n2, n4, n6, n12, ...} | OPTIONAL, |
| dl-prs-CombSizeN-Req-r17 | ENUMERATED {n2, n4, n6, n12, ...} | OPTIONAL, |
| dl-prs-QCL-InformationReqTRPlist-r17 | DL-PRS-QCL-InformationReqTRPlist-r17 | OPTIONAL, |

...
}
NR-On-Demand-DL-PRS-Information field descriptions
dl-prs-ResourceSetPeriodicityReq
This field specifies the requested periodicity of the DL-PRS Resource Set in slots. The periodicity depends on the subcarrier
spacing (SCS) and takes values 2^{μ}{4, 5, 8, 10, 16, 20, 32, 40, 64, 80, 160, 320, 640, 1280, 2560, 5120, 10240}
slots, where μ = 0, 1, 2, 3 for SCS of 15, 30, 60 and 120 kHz respectively. μ refers to the target devices current primary cell.

With reference to Table 8, the UE may express the requested DL-PRS transmission period in units of a slot through dl-prs-ResourceSetPeriodicityReq-r17.

In this case, the actual DL-PRS transmission period may vary according to a Subcarrier spacing (SCS) value that serves as the basis. This is because the actual slot length (slot time length) varies according to the SCS value.

For example, in the case that “32 slots” are indicated through the dl-prs-ResourceSetPeriodicityReq-r17 field, the requested DL-PRS transmission period may be interpreted as “32 msec” assuming “15 kHz” (μ=0) as the SCS value, be interpreted as “16 msec” assuming “30 kHz” (μ=1) as the SCS value, be interpreted as “8 msec” assuming “60 kHz” (μ=2) as the SCS value, and be interpreted as “4 msec” assuming “120 kHz” (μ=3) as the SCS value.

Because the DL-PRS period indicated in units of a slot through the dl-prs-ResourceSetPeriodicityReq-r17 field may be interpreted differently according to the SCS value (p value) that serves as the basis, as described above, it is described that the value in the description of the dl-prs-ResourceSetPeriodicityReq-r17 field refers to a current primary cell of a positioning target device. This means to use a SCS (value) of a primary cell of the UE as the SCS (value) that serves as the basis for calculating the DL-PRS period value requested by the LMF when the DL-PRS period value requested by the UE is indicated in units of a slot through the ResourceSetPeriodicityReq-r17 field.

However, according to the current standard, there is no way for the LMF to determine the SCS (value) of the primary cell of the UE. Therefore, even if the UE provides the DL-PRS period requested in units of a slot to the LMF through the dl-prs-ResourceSetPeriodicityReq-r17 field in step 125, in reality, the LMF may not determine exactly what value (time value) the UE requested in the DL-PRS period.

The disclosure provides a method for resolving the ambiguity or problem when the LMF interprets the DL-PRS period value requested by the UE. In the disclosure for solving the above-described problem, one of the following methods may be used.

Method 1 (Introduce a new field to indicate the reference SCS (μ) for the requested periodicity)

The UE may explicitly provide the SCS (μ) value that serves as the basis when converting a period value of DL-PRS to an absolute time. More specifically, the UE may explicitly provide the LMF with the SCS (μ) value that serves as the basis (or reference) when the LMF converts the DL-PRS period value requested in units of a slot through the dl-prs-ResourceSetPeriodicityReq-r17 field into an absolute time value.

In this case, the SCS (μ) value provided by the UE may be an SCS value of the primary cell of the UE (Method 1-1) or a reference SCS (μ) value used for simply calculating the requested DL-PRS period value regardless of the SCS value of the primary cell (Method 1-2). Specifically, embodiments of each method are illustrated in Tables 9 and 10.

In the case that the UE according to method 1-1 provides the SCS value of the primary cell to the LMF, the specific message fields may be as illustrated in [Table 9].

TABLE 9
In the case that the UE provides the SCS value of the primary cell to the LMF

| NR-On-Demand-DL-PRS-PerFreqLayer-r17 ::= SEQUENCE { | |
|---|---|
| dl-prs-FrequencyRangeReq-r17 | ENUMERATED { fr1, fr2, ...}, |
| dl-prs-ResourceSetPeriodicityReq-r17 | ENUMERATED { p4, p5, p8, p10, p16, p20, p32, p40, |
| | p64, p80, p160, p320, p640, p1280, p2560, |
| | p5120, p10240, p20480, p40960, p81920, ...} |

| | | |
|---|---|---|
| | | OPTIONAL, |
| dl-prs-ResourceBandwidthReq-r17 | INTEGER (1..63) | OPTIONAL, |
| dl-prs-ResourceRepetitionFactorReq-r17 | ENUMERATED {n2, n4, n6, n8, n16, n32, ...} | OPTIONAL, |
| dl-prs-NumSymbolsReq-r17 | ENUMERATED {n2, n4, n6, n12, ...} | OPTIONAL, |
| dl-prs-CombSizeN-Req-r17 | ENUMERATED {n2, n4, n6, n12, ...} | OPTIONAL, |
| dl-prs-QCL-InformationReqTRPlist-r17 | DL-PRS-QCL-InformationReqTRPlist-r17 | OPTIONAL, |

```
  ...
  [[
  dl-prs-PrimaryCellSCS-v17xy ENUMERATED {kHz15, kHz30, kHz60, kHz120, ...} OPTIONAL --Cond Periodicity
  ]]
}
```

NR-On-Demand-DL-PRS-Information field descriptions
dl-prs-PrimaryCellSCS
This field specifies the SCS of the target device's current primary cell.
dl-prs-ResourceSetPeriodicityReq
This field specifies the requested periodicity of the DL-PRS Resource Set in slots. The periodicity depends on the subcarrier
spacing (SCS) and takes values 2^{μ}{4, 5, 8, 10, 16, 20, 32, 40, 64, 80, 160, 320, 640, 1280, 2560, 5120, 10240} slots, where
μ = 0, 1, 2, 3 for SCS of 15, 30, 60 and 120 kHz respectively. μ refers to the target devices current primary cell.

In the case of following method 1-1, the UE may explicitly provide the SCS (μ) value of a primary cell of the UE to the LMF through a newly defined dl-prs-PrimaryCellSCS-v17xy field.

The LMF may calculate an absolute time value of the DL-PRS period requested by the UE by multiplying the DL-PRS period value requested in units of a slot through the dl-prs-ResourceSetPeriodicityReq-r17 field by the slot length corresponding to the SCS (μ) value indicated through the dl-prs-PrimaryCellSCS-v17xy field. The SCS (μ) value indicated through the dl-prs-PrimaryCellSCS-v17xy field may be indicated as any one of 15 kHz, 30 kHz, 60 kHz, and 120 kHz.

In this case, the dl-prs-PrimaryCellSCS-v17xy field may be together configured (included) only in the case that the dl-prs-ResourceSetPeriodicityReq-r17 field is configured (included). For this purpose, a conditional presence code “-Cond Periodicity” may be used.

In the case that the UE according to method 1-2 provides the LMF with a reference SCS (μ) value used regardless of the SCS value of the primary cell, the specific message field may be as illustrated in [Table 10].

TABLE 10
In the case that the UE provides the reference SCS (μ)
value used for calculating the DL-PRS period value to the LMF

NR-On-Demand-DL-PRS-PerFreqLayer-r17 ::= SEQUENCE {

| dl-prs-FrequencyRangeReq-r17 | ENUMERATED { fr1, fr2, ...}, | |
|---|---|---|
| dl-prs-ResourceSetPeriodicityReq-r17 | ENUMERATED { p4, p5, p8, p10, p16, p20, p32, p40, | |
| | p64, p80, p160, p320, p640, p1280, p2560, | |
| | p5120, p10240, p20480, p40960, p81920, ...} | |
| | | OPTIONAL, |
| dl-prs-ResourceBandwidthReq-r17 | INTEGER (1..63) | OPTIONAL, |
| dl-prs-ResourceRepetitionFactorReq-r17 | ENUMERATED {n2, n4, n6, n8, n16, n32, ...} | |
| | | OPTIONAL, |
| dl-prs-NumSymbolsReq-r17 | ENUMERATED {n2, n4, n6, n12, ...} | OPTIONAL, |
| dl-prs-CombSizeN-Req-r17 | ENUMERATED {n2, n4, n6, n12, ...} | OPTIONAL, |
| dl-prs-QCL-InformationReqTRPlist-r17 | DL-PRS-QCL-InformationReqTRPlist-r17 | OPTIONAL, |

```
  ...
  [[
  dl-prs-ReferenceSCS-v17xy ENUMERATED {kHz15, kHz30, kHz60, kHz120, ...} OPTIONAL --Cond Periodicity
  ]]
}
NR-On-Demand-DL-PRS-Information field descriptions
dl-prs-ReferenceSCS
This field specifies the reference SCS for dl-prs-ResourceSetPeriodicityReq-r17.
dl-prs-ResourceSetPeriodicityReq
This field specifies the requested periodicity of the DL-PRS Resource Set in slots. The periodicity depends on the subcarrier
spacing (SCS) and takes values 2^{μ}{4, 5, 8, 10, 16, 20, 32, 40, 64, 80, 160, 320, 640, 1280, 2560, 5120, 10240} slots, where
μ = 0, 1, 2, 3 for SCS of 15, 30, 60 and 120 kHz respectively. μ refers to dl-prs-ReferenceSCS-v17xy.

[symbol]

[symbol]

```

In the case of following method 1-2, the UE may explicitly provide the LMF with the reference SCS (μ) value used for calculating the DL-PRS period value through the newly defined dl-prs-ReferenceSCS-v17xy field.

The LMF may calculate an absolute time value of the DL-PRS period requested by the UE by multiplying the DL-PRS period value requested in units of a slot through the dl-prs-ResourceSetPeriodicityReq-r17 field by the slot length corresponding to the SCS (μ) value indicated through the dl-prs-ReferenceSCS-v17xy field. The SCS (μ) value indicated through the dl-prs-ReferenceSCS-v17xy field may be indicated as any one of 15 kHz, 30 kHz, 60 kHz, and 120 kHz.

In this case, the dl-prs-ReferenceSCS-v17xy field may be together configured (included) only in the case that the dl-prs-ResourceSetPeriodicityReq-r17 field is configured (included). For this purpose, the conditional presence code “—Cond Periodicity” may be used.

In embodiments of Tables 9 and 10, there was described only the case that an SCS (μ) value required to calculate an absolute time value of the DL-PRS period requested by the UE is included within NR-On-Demand-DL-PRS-PerFreqLayer-r17 IE in units of a frequency layer. However, in order to provide the SCS (μ) value to the LMF, the UE may include the newly defined field (dl-prs-PrimaryCellSCS-v17xy or dl-prs-ReferenceSCS-v17xy) in CommonlEsRequestAssistanceData IE or in NR-On-Demand-DL-PRS-Request-r17 IE in units of a request message.

Additionally, in embodiments of Tables 9 and 10, an ENUMERATED type data structure was used for indicating one value of {15 kHz, 30 kHz, 60 kHz, 120 kHz} as the SCS (μ) value required to calculate an absolute time value of the DL-PRS period requested by the UE. Considering that there are restrictions on the SCS (μ) values that may be supported for each actual frequency range, a signaling load may be reduced by using a CHOICE structure, as illustrated in Table 11.

TABLE 11
Example of using a CHOICE structure

NR-On-Demand-DL-PRS-PerFreqLayer-r17 ::= SEQUENCE {

| dl-prs-FrequencyRangeReq-r17 | ENUMERATED { fr1, fr2, ...}, | |
|---|---|---|
| dl-prs-ResourceSetPeriodicityReq-r17 | ENUMERATED { p4, p5, p8, p10, p16, p20, p32, p40, | |
| | p64, p80, p160, p320, p640, p1280, p2560, | |
| | p5120, p10240, p20480, p40960, p81920, ...} | |
| | | OPTIONAL, |
| dl-prs-ResourceBandwidthReq-r17 | INTEGER (1..63) | OPTIONAL, |
| dl-prs-ResourceRepetitionFactorReq-r17 | ENUMERATED {n2, n4, n6, n8, n16, n32, ...} | |
| | | OPTIONAL, |
| dl-prs-NumSymbolsReq-r17 | ENUMERATED {n2, n4, n6, n12, ...} | OPTIONAL, |
| dl-prs-CombSizeN-Req-r17 | ENUMERATED {n2, n4, n6, n12, ...} | OPTIONAL, |
| dl-prs-QCL-InformationReqTRPlist-r17 | DL-PRS-QCL-InformationReqTRPlist-r17 | OPTIONAL, |

```
    ...
    [[
    dl-prs-ReferenceSCS-v17xy (or dl-prs-PrimaryCellSCS-v17xy) CHOICE {
```

| | |
|---|---|
| FR1-SCS-v17xy | ENUMERATED {kHz15, kHz30, kHz60, ...} |
| FR2-SCS-v17xy | ENUMERATED {kHz120, ... |

```
  } OPTIONAL --Cond Periodicity
    ]]
}
```

Method 2 (Introduce a new field to indicate the requested SCS (μ))

The UE may explicitly request the SCS (μ) value used for DL-PRS transmission to the LMF.

In the case of Method 1 described above, the SCS (μ) value provided by the UE to the LMF is only for the LMF to calculate the requested DL-PRS transmission period, and does not imply that the UE requests to actually transmit DL-PRS using the SCS (μ) value provided by the UE to the LMF. However, Method 2 is different in that the UE explicitly requests the SCS (μ) value used for actual DL-PRS transmission to the LMF.

In Method 2, the SCS (μ) value requested by the UE may be used as the SCS (μ) value that serves as the basis (or reference) when the LMF converts the DL-PRS period value requested in units of a slot through the dl-prs-ResourceSetPeriodicityReq-r17 field into an absolute time value. A specific embodiment according to Method 2 may be as illustrated in Table 12.

TABLE 12
In the case that the UE requests the SCS (μ) value to be used when transmitting the DL-PRS to the LMF

NR-On-Demand-DL-PRS-PerFreqLayer-r17 ::= SEQUENCE {

| dl-prs-FrequencyRangeReq-r17 | ENUMERATED { fr1, fr2, ...}, | |
|---|---|---|
| dl-prs-ResourceSetPeriodicityReq-r17 | ENUMERATED { p4, p5, p8, p10, p16, p20, p32, p40, | |
| | p64, p80, p160, p320, p640, p1280, p2560, | |
| | p5120, p10240, p20480, p40960, p81920, ...} | |
| | | OPTIONAL, |
| dl-prs-ResourceBandwidthReq-r17 | INTEGER (1..63) | OPTIONAL, |
| dl-prs-ResourceRepetitionFactorReq-r17 | ENUMERATED {n2, n4, n6, n8, n16, n32, ...} | |
| | | OPTIONAL, |
| dl-prs-NumSymbolsReq-r17 | ENUMERATED {n2, n4, n6, n12, ...} | OPTIONAL, |
| dl-prs-CombSizeN-Req-r17 | ENUMERATED {n2, n4, n6, n12, ...} | OPTIONAL, |
| dl-prs-QCL-InformationReqTRPlist-r17 | DL-PRS-QCL-InformationReqTRPlist-r17 | OPTIONAL, |

```
  ...
  [[
  dl-prs-SCS-Req-v17xy ENUMERATED { kHz15, kHz30, kHz60, kHz120, ...} OPTIONAL
  ]]
}
NR-On-Demand-DL-PRS-Information field descriptions
dl-prs-SCS-Req
This field specifies the requested SCS of the DL-PRS Resource Set in kHz.
dl-prs-ResourceSetPeriodicityReq
This field specifies the requested periodicity of the DL-PRS Resource Set in slots. The periodicity depends on the
subcarrier spacing (SCS) and takes values
2^{μ}{4, 5, 8, 10, 16, 20, 32, 40, 64, 80, 160, 320, 640, 1280, 2560, 5120, 10240} slots, where μ = 0, 1, 2, 3 for SCS of 15,
30, 60 and 120 kHz respectively. μ refers to dl-prs-SCS-Req-v17xy. [symbol]
```

In the case of method 2, the UE may explicitly provide the requested DL-PRS transmission SCS (t) value to the LMF through the newly defined dl-prs-SCS-Req-v17xy field. The LMF may calculate an absolute time value of the DL-PRS period requested by the UE by multiplying the DL-PRS period value requested in units of a slot through the dl-prs-ResourceSetPeriodicityReq-r17 field by the slot length corresponding to the SCS (μ) value indicated through the dl-prs-SCS-Req-v17xy field. The SCS (μ) value indicated through the dl-prs-SCS-Req-v17xy field may be indicated as any one of 15 kHz, 30 kHz, 60 kHz, and 120 kHz.

In the embodiment of Table 12, only the case that a DL-PRS transmission SCS (μ) value requested by the UE is included in NR-On-Demand-DL-PRS-PerFreqLayer-r17 IE in units of a frequency layer was described. However, in order to provide the SCS (μ) value to the LMF, the UE may include the newly defined field dl-prs-SCS-Req-v17xy within a CommonlEsRequestAssistanceData IE or NR-On-Demand-DL-PRS-Request-r17 IE in units of the request message.

In the embodiment of Table 12, an ENUMERATED type data structure was used for indicating one value of {15 kHz, 30 kHz, 60 kHz, 120 kHz} as a DL-PRS transmission SCS (μ) value requested by the UE, and considering that there are restrictions on SCS (μ) values that may be supported for each actual frequency range, a signaling load may be reduced by using a CHOICE structure similar to Table 11.

Method 3 (Introduce a new field to indicate the requested periodicity in msec):

In order to clearly provide the requested DL-PRS transmission period value to the LMF, the UE may define a new field ‘dl-prs-ResourceSetPeriodicityReq2-v17xy’ indicating the transmission period as an absolute time value in units of msec. The absolute time value indicated through the dl-prs-ResourceSetPeriodicityReq2-v17xy field may be indicated as ms4, ms5, ms8, ms16, and the like.

In the case of using the method 3, the DL-PRS transmission period is indicated in units of a slot through the existing dl-prs-ResourceSetPeriodicityReq-r17 field, and a signaling load is reduced compared to a method in which the SCS (μ) value that serves as the basis is separately provided to calculate this as an absolute time value. Further, the need to additionally calculate the DL-PRS transmission period at an LMF stage disappears.

However, in the case that a new field dl-prs-ResourceSetPeriodicityReq2-v17xy is introduced to indicate the DL-PRS transmission period requested in units of msec, the U may include only one field of the existing field dl-prs-ResourceSetPeriodicityReq-r7 and the new field. A specific embodiment of the method 3 may be illustrated in Table 13.

TABLE 13
Method in which the UE provides the requested DL-PRS transmission period in units of msec to the LMF

NR-On-Demand-DL-PRS-PerFreqLayer-r17 :: = SEQUENCE {

| dl-prs-FrequencyRangeReq-r17 | ENUMERATED { fr1, fr2, ...}, | |
|---|---|---|
| dl-prs-ResourceSetPeriodicityReq-r17 | ENUMERATED { p4, p5, p8, p10, p16, p20, p32, p40, | |
| | p64, p80, p160, p320, p640, p1280, p2560, | |
| | p5120, p10240, p20480, p40960, p81920, ...} | |
| | | OPTIONAL, |
| dl-prs-ResourceBandwidthReq-r17 | INTEGER (1..63) | OPTIONAL, |
| dl-prs-ResourceRepetitionFactorReq-r17 | ENUMERATED {n2, n4, n6, n8, n16, n32, ...} | |
| | | OPTIONAL, |
| dl-prs-NumSymbolsReq-r17 | ENUMERATED {n2, n4, n6, n12, ...} | OPTIONAL, |
| dl-prs-CombSizeN-Req-r17 | ENUMERATED {n2, n4, n6, n12, ...} | OPTIONAL, |
| dl-prs-QCL-InformationReqTRPlist-r17 | DL-PRS-QCL-InformationReqTRPlist-r17 | OPTIONAL, |

```
  ...
  [[
  dl-prs-ResourceSetPeriodicityReq2-v17xy ENUMERATED {ms4, ms5, ms8, ms10, ms16, ms20, ms32,
ms40, ms64, ms80, ms160, ms320, ms640, ms1280, ms2560, ms5120, ms10240, ...} OPTIONAL
  ]]
}
NR-On-Demand-DL-PRS-Information field descriptions
dl-prs-ResourceSetPeriodicityReq2
This field specifies the requested periodicity of the DL-PRS Resource Set in msec. This field is not set
simultaneously with dl-prs-ResourceSetPeriodicityReq-r17.
dl-prs-ResourceSetPeriodicityReq
This field specifies the requested periodicity of the DL-PRS Resource Set in slots. The periodicity depends on the
subcarrier spacing (SCS) and takes values
2^{μ}{4, 5, 8, 10, 16, 20, 32, 40, 64, 80, 160, 320, 640, 1280, 2560, 5120, 10240} slots, where μ = 0, 1, 2, 3 for SCS of 15,
30, 60 and 120 kHz respectively. This field is not set simultaneously with dl-prs-ResourceSetPeriodicityReq2-
v17xy. [symbol]
```

Method 4 (LMF refers to the subcarrier spacing in SSB information provided by the serving gNB/TRP)

The LMF may calculate an absolute time value of the requested DL-PRS transmission period based on the SCS (t) value included in SSB configuration information of a primary cell of the UE.

More specifically, the LMF may receive SSB configuration information (SSB Information) transmitted from the primary cell of the UE from the gNB 103 through the NRPPa TRP information exchange procedure in step 110. In this case, the SSB information may include the SCS (μ) value used for SSB transmission. Therefore, when the UE provides the dl-PRS transmission period requested in units of a slot to the LMF through the dl-prs-ResourceSetPeriodicityReq-r17 field as before, the LMF may calculate an absolute time value of the requested DL-PRS transmission period based on the SCS (μ) value (based on the slot length when using the corresponding SCS value) included in SSB configuration information of the primary cell of the UE.

For method 4, the UE does not need to provide additional information to the LMF, but the content that the LMF may refer to SSB Information of the primary cell of the UE in order to convert DL-PRS transmission period information requested by the UE in units of a slot into an absolute time value may be included in the specification, as illustrated in Table 14.

However, in the case that the primary cell of the UE has multiple SSB transmission configurations and that the SCS (μ) value included in each SSB transmission configuration information is different, there is ambiguity or a problem when the LMF interprets the DL-PRS period value requested by the UE.

TABLE 14
In the case that the LMF refers to the SCS (μ) value in SSB configuration information of the primary cell of the UE
NR-On-Demand-DL-PRS-Information field descriptions

dl-prs-ResourceSetPeriodicityReq
This field specifies the requested periodicity of the DL-PRS Resource Set in slots. The periodicity depends on
the subcarrier spacing (SCS) and takes values
2^{μ}{4, 5, 8, 10, 16, 20, 32, 40, 64, 80, 160, 320, 640, 1280, 2560, 5120, 10240} slots, where μ = 0, 1, 2, 3 for SCS of
15, 30, 60 and 120 kHz respectively. μ refers to subcarrier spacing in SSB Information for the target device's
current primary cell.

Method 5 (Leave the ambiguity, but remove the part related to target device's primary cell).

It may follow LMF implementation whether the LMF is to convert the requested DL-PRS period in units of a slot into an absolute time value with reference to which SCS (μ) value.

More specifically, the UE may provide the DL-PRS period requested in units of a slot to the LMF through the dl-prs-ResourceSetPeriodicityReq-r17 field as before. However, the ambiguity as to which SCS (μ) value the LMF will refer to when converting the DL-PRS period requested in units of a slot to an absolute time value may be left to the LMF implementation.

However, even in this case, the expression that the LMF refers to an SCS (μ) value of the primary cell of the UE when calculating the requested DL-PRS period is incorrect; thus, the corresponding part may be deleted from the current standard, as illustrated in Table 15.

TABLE 15
NR-On-Demand-DL-PRS-Information field descriptions

dl-prs-ResourceSetPeriodicityReq
This field specifies the requested periodicity of the DL-PRS Resource Set in slots. The periodicity depends on
the subcarrier spacing (SCS) and takes values
2^{μ}{4, 5, 8, 10, 16, 20, 32, 40, 64, 80, 160, 320, 640, 1280, 2560, 5120, 10240} slots, where μ = 0, 1, 2, 3 for SCS of
15, 30, 60 and 120 kHz respectively.

[symbol]

As in the methods 1, 2 and 3, in order for the UE to provide additional information (e.g., dl-prs-ReferenceSCS-v17xy, dl-prs-SCS-Req-v17xy, dl-prs-ResourceSetPeriodicityReq2-v17xy) to the LMF, in the case that a new field is defined, new UE capability information indicating whether the UE supports the new field may be defined in the LPP ProvideCapabilities message. The new UE capability information may be exchanged between the UE 100 and the LMF 107 in step 115.

Additionally, as in methods 1, 2, and 3, in order for the UE to provide additional information to the LMF, in the case that a new field (e.g., dl-prs-ReferenceSCS-v17xy, dl-prs-SCS-Req-v17xy, dl-prs-ResourceSetPeriodicityReq2-v17xy) is defined, the LMF 107 may indicate whether the UE 100 may use a new field. For this purpose, a new indicator may be defined within LPP ProvideAssistanceData. In step 123, through the indicator, the LMF may indicate whether the UE may use a new field defined in the methods 1, 2, and 3.

Additionally, as in the methods 1, 2, and 3, in order for the UE to provide additional information to the LMF, in the case that a new field (e.g., dl-prs-ReferenceSCS-v17xy, dl-prs-SCS-Req-v17xy, dl-prs-ResourceSetPeriodicityReq2-v17xy) is defined, the LMF 107 may transmit the corresponding information to the base station in step 143. To this end, new fields corresponding to new fields provided in the methods 1, 2, and 3 may be defined in a requested DL PRS transmission characteristics IE included in the NRPPa PRS CONFIGURATION REQUEST message. NRPPa implementation embodiments corresponding to the methods 1, 2, and 3 are illustrated in Tables 16, 17, and 18.

In the case that the UE explicitly provides an SCS (μ) value that serves as the basis according to method 1, the NRPPa PRS CONFIGURATION REQUEST message may refer to Table 16.

TABLE 16

| | | | IE Type and | |
|---|---|---|---|---|
| IE/Group Name | Presence | Range | Reference | Semantics Description |
| Requested DL-PRS | | 1 | | |
| Resource Set List | | | | |
| >Requested DL- | | 1 | | |
| PRS Resource Set | | . . . <maxnoofPRSresourceSet> | | |
| Item | | | | |
| >>PRS bandwidth | O | | INTEGER(1 . . . 63) | 24, 28, . . . , 272 PRBs |
| >>Comb Size | O | | ENUMERATED | |
| | | | (2, 4, 6, 12, . . . ) | |
| >>Resource Set | O | | ENUMERATED | |
| Periodicity | | | (4, 5, 8, 10, 16, 20, 32, | |
| | | | 40, 64, 80, 160, | |
| | | | 320, 640, 1280, 2560, | |
| | | | 5120, 10240, 20480, | |
| | | | 40960, 81920, . . . ) | |
| >>Resource | O | | ENUMERATED | |
| Repetition Factor | | | (rf1, rf2, rf4, rf6, rf8, | |
| | | | rf16, rf32, . . . ) | |
| >>Resource Number | O | | ENUMERATED | |
| of Symbols | | | (n2, n4, n6, n12, . . . ) | |
| >>Requested DL- | O | | 9.2.62 | |
| PRS Resource List | | | | |
| >>Resource Set Start | O | | Start Time and | This IE is ignored if the |
| Time and Duration | | | Duration9.2.63 | Start Time and Duration |
| | | | | IE is present |
| >>Reference SCS | O | | ENUMERATED(15 kHz, | This IE is referred to |
| (Primary cell's scs) | | | 30 kHz, 60 kHz, | calculate the requested |
| | | | 120 kHz, . . . ) | DL-PRS periodicity with |
| | | | | Resource Set Periodicity |
| | | | | IE. |
| Number of Frequency | O | | INTEGER(1 . . . 4) | |
| Layers | | | | |
| Start Time and | O | | 9.2.63 | |
| Duration | | | | |

In the case that the UE explicitly requests the SCS (i) value used for actual DL-PRS transmission according to method 2, the NRPPa PRS CONFIGURATION REQUEST message may refer to Table 17.

TABLE 17

| | | | IE Type and | |
|---|---|---|---|---|
| IE/Group Name | Presence | Range | Reference | Semantics Description |
| Requested DL-PRS | | 1 | | |
| Resource Set List | | | | |
| >Requested DL- | | 1 | | |
| PRS Resource Set | | . . . <maxnoofPRSresourceSet> | | |
| Item | | | | |
| >>PRS bandwidth | O | | INTEGER(1 . . . 63) | 24, 28, . . . , 272 PRBs |
| >>Comb Size | O | | ENUMERATED | |
| | | | (2, 4, 6, 12, . . . ) | |
| >>Resource Set | O | | ENUMERATED | |
| Periodicity | | | (4, 5, 8, 10, 16, 20, 32, | |
| | | | 40, 64, 80, 160, 320, | |
| | | | 640, 1280, 2560, | |
| | | | 5120, 10240, 20480, | |
| | | | 40960, 81920, . . . ) | |
| >>Resource | O | | ENUMERATED | |
| Repetition Factor | | | (rf1, rf2, rf4, rf6, rf8, | |
| | | | rf16, rf32, . . . ) | |
| >>Resource Number | O | | ENUMERATED | |
| of Symbols | | | (n2, n4, n6, n12, . . . ) | |
| >>Requested DL- | O | | 9.2.62 | |
| PRS Resource List | | | | |
| >>Resource Set Start | O | | Start Time and | This IE is ignored if the |
| Time and Duration | | | Duration9.2.63 | Start Time and Duration |
| | | | | IE is present |
| >>Resource Set | O | | ENUMERATED(15 kHz, | |
| SCS | | | 30 kHz, 60 kHz, | |
| | | | 120 kHz, . . . ) | |
| Number of Frequency | O | | INTEGER(1 . . . 4) | |
| Layers | | | | |
| Start Time and | O | | 9.2.63 | |
| Duration | | | | |

According to method 3, in the case that the UE provides an absolute time value in units of msec, the NRPPa PRS CONFIGURATION REQUEST message may refer to Table 18.

TABLE 18

| | | | IE Type and | |
|---|---|---|---|---|
| IE/Group Name | Presence | Range | Reference | Semantics Description |
| Requested DL-PRS | | 1 | | |
| Resource Set List | | | | |
| >Requested DL- | | 1 | | |
| PRS Resource Set | | . . . <maxnoofPRSresourceSet> | | |
| Item | | | | |
| >>PRS bandwidth | O | | INTEGER(1 . . . 63) | 24, 28, . . . , 272 PRBs |
| >>Comb Size | O | | ENUMERATED | |
| | | | (2, 4, 6, 12, . . . ) | |
| >>Resource Set | O | | ENUMERATED | |
| Periodicity | | | (4, 5, 8, 10, 16, 20, | |
| | | | 32, 40, 64, 80, 160, | |
| | | | 320, 640, 1280, 2560, | |
| | | | 5120, 10240, 20480, | |
| | | | 40960, 81920, . . . ) | |
| >>Resource | O | | ENUMERATED | |
| Repetition Factor | | | (rf1, rf2, rf4, rf6, rf8, | |
| | | | rf16, rf32, . . . ) | |
| >>Resource Number | O | | ENUMERATED | |
| of Symbols | | | (n2, n4, n6, n12, . . . ) | |
| >>Requested DL- | O | | 9.2.62 | |
| PRS Resource List | | | | |
| >>Resource Set Start | O | | Start Time and | This IE is ignored if the |
| Time and Duration | | | Duration9.2.63 | Start Time and Duration |
| | | | | IE is present |
| >>Resource Set | O | | ENUMERATED(ms4, | |
| Periodicity2 | | | ms5, ms8, | |
| | | | ms10, ms16, | |
| | | | ms20, ms32, | |
| | | | ms40, ms64, | |
| | | | ms80, ms160, | |
| | | | ms320, ms640, | |
| | | | ms1280, | |
| | | | ms2560, | |
| | | | ms5120, | |
| | | | ms10240, . . . ) | |
| Number of Frequency | O | | INTEGER(1 . . . 4) | |
| Layers | | | | |
| Start Time and | O | | 9.2.63 | |
| Duration | | | | |

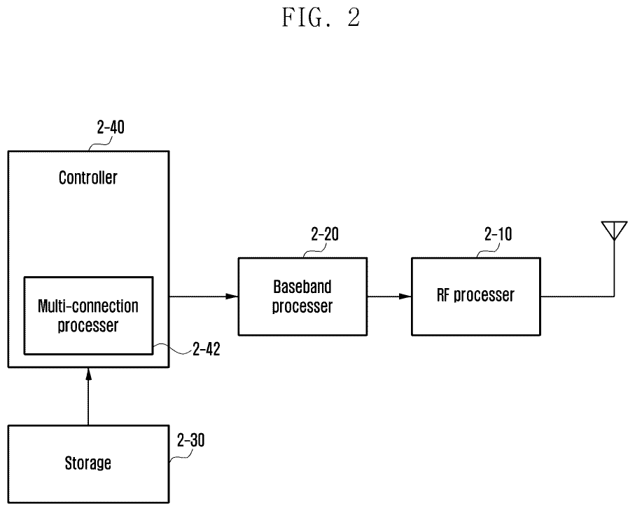

FIG. 2 illustrates a structure of a UE according to an embodiment of the disclosure.

With reference to FIG. 2, the UE may include a radio frequency (RF) processer 2-10, a baseband processer 2-20, a storage 2-30, and a controller 2-40. Components of the UE are not limited to illustrative components illustrated in FIG. 2, and may include fewer or more components than those illustrated in FIG. 2.

The RF processer 2-10 may perform functions for transmitting and receiving signals through a wireless channel, such as band conversion and amplification of signals. For example, the RF processer 2-10 may up-convert a baseband signal provided from the baseband processer 2-20 into an RF band signal and transmit the signal through an antenna, and down-convert the RF band signal received through the antenna into a baseband signal. For example, the RF processer 2-10 may include a transmission filter, a reception filter, an amplifier, a mixer, an oscillator, a digital to analog convertor (DAC), an analog to digital convertor (ADC), and the like, but the disclosure is not limited to these examples.

In FIG. 2, only one antenna is illustrated, but the UE may be equipped with a plurality of antennas. Further, the RF processer 2-10 may include a plurality of RF chains. Furthermore, the RF processer 2-10 may perform beamforming. For beamforming, the RF processer 2-10 may adjust a phase and size of each signal transmitted and received through a plurality of antennas or antenna elements. Further, the RF processer 2-10 may perform MIMO and receive multiple layers when performing a MIMO operation.

The baseband processer 2-20 may perform a conversion function between baseband signals and bit strings according to the physical layer specifications of the system. For example, when transmitting data, the baseband processer 2-20 may encode and modulate the transmission bit string to generate complex symbols. Further, when receiving data, the baseband processer 2-20 may demodulate and decode the baseband signal provided from the RF processer 2-10 to restore the received bit string. For example, in the case of following an orthogonal frequency division multiplexing (OFDM) method, when transmitting data, the baseband processer 2-20 may encode and modulate the transmission bit string to generate complex symbols, and map the generated complex symbols to subcarriers and then constitute OFDM symbols through inverse fast Fourier transform (IFFT) operation and cyclic prefix (CP) insertion.

Further, when receiving data, the baseband processer 2-20 may divide the baseband signal provided from the RF processer 2-10 in units of an OFDM symbol and restore signals mapped to subcarriers through fast Fourier transform (FFT) operation and then restore the received bit string through demodulation and decoding.

The baseband processer 2-20 and the RF processer 2-10 may transmit and receive signals, as described above. Accordingly, the baseband processer 2-20 and the RF processer 2-10 may be referred to as a transmitter, a receiver, a transceiver, or a communication circuit. Furthermore, at least one of the baseband processer 2-20 or the RF processer 2-10 may include a plurality of communication modules in order to support a plurality of different wireless access technologies. Further, at least one of the baseband processer 2-20 or the RF processer 2-10 may include different communication modules in order to process signals in different frequency bands. For example, different wireless access technologies may include wireless LAN (e.g., IEEE 802.11), cellular network (e.g., LTE), and the like.

Further, different frequency bands may include a super high frequency (SHF) (e.g., 2.NRHz, NRhz) band and a millimeter wave (e.g., 60 GHz) band. The UE may transmit and receive signals to and from the gNB using the baseband processer 2-20 and the RF processer 2-10, and the signals may include control information and data.

The storage 2-30 may store data such as basic programs, application programs, and configuration information for operation of the UE. For example, the storage 2-30 may store data information such as basic programs, application programs, and configuration information for operation of the UE. The storage 2-30 may provide stored data according to the request from the controller 2-40.

The storage 2-30 may be composed of a storage medium such as a ROM, RAM, hard disk, CD-ROM, and DVD, or a combination of storage media. Further, the storage 2-30 may be composed of a plurality of memories. According to an embodiment of the disclosure, the storage 2-30 may store a program for performing a handover method according to the disclosure.

The controller 2-40 may control the overall operations of the UE. For example, the controller 2-40 may transmit and receive signals through the baseband processer 2-20 and the RF processer 2-10.

Further, the controller 2-40 may write data in the storage 2-30 and read data from the storage 2-30. For this purpose, the controller 2-40 may include at least one processor. For example, the controller 2-40 may include a communication processor (CP) that performs the control for communication and an application processor (AP) that controls upper layers such as application programs. Further, according to an embodiment of the disclosure, the controller 2-40 may include a multi-connection processer 2-42 configured to process a process operating in a multi-connection mode. Further, at least one component within the UE may be implemented into one chip.

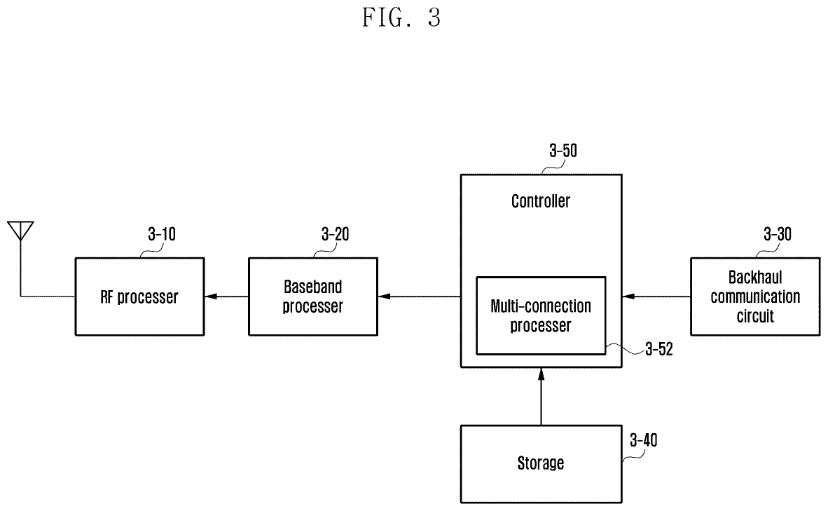

FIG. 3 illustrates a structure of a base station according to an embodiment of the disclosure.

The base station of FIG. 3 may be included in the network described above. As illustrated in FIG. 3, the base station may include an RF processer 3-10, a baseband processer 3-20, a backhaul communication circuit 3-30, a storage 3-40, and a controller 3-50.

Components of the base station are not limited to the illustrative components illustrated in FIG. 3, and the base station may include fewer or more components than those illustrated in FIG. 3.

The RF processer 3-10 may perform functions for transmitting and receiving signals through a wireless channel, such as band conversion and amplification of signals. For example, the RF processer 3-10 may up-convert a baseband signal provided from the baseband processer 3-20 into an RF band signal and transmit the signal through an antenna, and down-convert the RF band signal received through the antenna into a baseband signal. For example, the RF processer 3-10 may include a transmission filter, reception filter, amplifier, mixer, oscillator, digital-to-analog convertor (DAC), analog-to-digital convertor (ADC), and the like. In FIG. 3, only one antenna is illustrated, but the RF processer 3-10 may be equipped with a plurality of antennas. Further, the RF processer 3-10 may include a plurality of RF chains. Furthermore, the RF processer 3-10 may perform beamforming. For beamforming, the RF processer 3-10 may adjust a phase and size of each signal transmitted and received through a plurality of antennas or antenna elements. The RF processer 3-10 may transmit one or more layers to perform a downlink MIMO operation.

The baseband processer 3-20 may perform a conversion function between baseband signals and bit strings according to physical layer standards. For example, when transmitting data, the baseband processer 3-20 may encode and modulate the transmission bit string to generate complex symbols. Further, when receiving data, the baseband processer 3-20 may demodulate and decode the baseband signal provided from the RF processer 3-10 to restore the received bit string. For example, in the case of following the OFDM method, when transmitting data, the baseband processer 3-20 may encode and modulate the transmission bit string to generate complex symbols, and map the generated complex symbols to subcarriers and then constitute OFDM symbols through IFFT operation and CP insertion.

Further, when receiving data, the baseband processer 3-20 may divide a baseband signal provided from the RF processer 3-10 in units of an OFDM symbol and restore signals mapped to subcarriers through FFT operation and then restore the received bit string through demodulation and decoding. The baseband processer 3-20 and the RF processer 3-10 may transmit and receive signals, as described above. Accordingly, the baseband processer 3-20 and the RF processer 3-10 may be referred to as a transmitter, a receiver, a transceiver, a communication circuit, or a RF. The base station may transmit and receive signals to and from the UE using the baseband processer 3-20 and the RF processer 3-10, and the signals may include control information and data.

The backhaul communication circuit 3-30 may provide an interface for communicating with other nodes in the network. For example, the backhaul communication circuit 3-30 may convert a bit string transmitted from the main base station to another node, for example, an auxiliary base station, a core network, and the like into a physical signal, and convert the physical signal received from the other node into a bit string.

The storage 3-40 may store data such as basic programs, application programs, and configuration information for the operation of the main base station. For example, the storage 3-40 may store information on bearers assigned to the accessed UE, measurement results reported from the accessed UE, and the like. Further, the storage 3-40 may store information that serves as a criterion for determining whether to provide or suspend multiple connections to the UE. The storage 3-40 may provide stored data according to the request from the controller 3-50. The storage 3-40 may be composed of a storage medium such as a ROM, RAM, hard disk, CD-ROM, and DVD, or a combination of storage media. Further, the storage 3-40 may be composed of a plurality of memories. According to an embodiment of the disclosure, the storage 3-40 may store a program for performing handover according to the disclosure.

The controller 3-50 may control the overall operations of the main base station. For example, the controller 3-50 may transmit and receive signals through the baseband processer 3-20 and the RF processer 3-10 or through the backhaul communication circuit 3-30. Further, the controller 3-50 may write data in the storage 3-40 and read data from the storage 3-40. For this purpose, the controller 3-50 may include at least one processor. Further, according to an embodiment of the disclosure, the controller 3-50 may include a multi-connection processer 3-52 configured to process a process operating in a multi-connection mode.

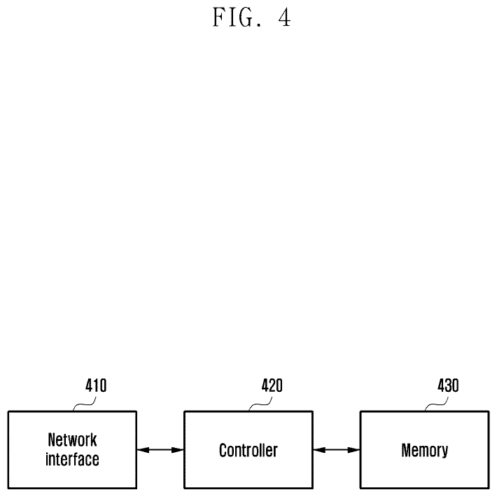

FIG. 4 illustrates a structure of a network function (NF) according to an embodiment of the disclosure.

Before describing FIG. 4, the network function (NF) may be any one of a user plane function (UPF), an access and mobility management function (AMF), and a location management function (LMF) described in this disclosure.

With reference to FIG. 4, a network interface 410 may communicate with other network entities in a core network. For example, in the case that the NF is an AMF, the NF may perform communication with an UPF, SMF, PCF, UDR, UDM, TSNAF, TSCTSF, NEF, CNC, AF, and the like. As another example, in the case that the NF is a PCF, the NF may perform communication with an UPF, AMF, SMF, UDR, UDM, TSNAF, TSCTSF, NEF, CNC, AF, and the like. Similarly, in the case that the NF is a specific network entity, the network interface may communicate with other entities in the core network. The network interface may be implemented into hardware of a specific circuit/logic.

A controller 420 may be implemented into at least one processor or/and program for performing an operation of the NF. For example, in the case that the NF is an AMF, the controller 420 may perform an operation of the AMF described above. As another example, in the case that the NF is a PCF, the controller 420 may perform the above-described operation of the PCF. Even in the case that the NF is another network entity, the controller 420 may perform the control required for operations described above in the same way.

A memory 430 may store programs and various control information needed by the controller 420, and store each piece of information described in this disclosure. The memory 430 may be implemented in various forms, and be implemented in any form such as a semiconductor memory, buffer, hard disk, RAM, or ROM. Further, for example, in the case that the NF is an AMF, the memory 430 may store information received from the AMF described above or from an external entity. As another example, in the case that the NF is a PCF, the memory 430 may store the necessary control information or/and received information in the above-described PCF. As another example, in the case that the NF is a UDM, the memory 430 may store various information such as information related to a user device and information for control in the UDM. As another example, in the case that the NF is an SMF, the memory 430 may store various data described above and data for control. Even in the case that the NF is another network entity, the memory 430 may store information necessary for the operations described above in the same manner.

In addition to the components described above, the NF may further include various interfaces for access to the operator. The disclosure does not place any special restrictions on these additional components.

It is noted that the constitution diagrams, illustrative diagrams of control/data signal transmission and reception methods, and illustrative operation procedure diagrams illustrated in FIGS. 1 to 4 are not intended to limit the scope of the embodiments of the disclosure. That is, all components, entities, or operational steps described in FIGS. 1 to 4 should not be construed as essential elements for carrying out the disclosure, and the inclusion of only some elements may be implemented in a range that does not impair the essence of the disclosure.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs include instructions for causing an electronic device to execute methods according to embodiments described in a claim or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), any other form of optical storage device, or a magnetic cassette. Alternatively, the programs may be stored in a memory composed of a combination of some or all thereof. Further, each constitution memory may be included in the plural.

Further, the program may be stored in an attachable storage device that may access through a communication network such as the Internet, Intranet, local area network (LAN), wide LAN (WLAN), or storage area Network (SAN), or a communication network composed of a combination thereof. Such a storage device may access to a device implementing an embodiment of the disclosure through an external port. Further, a separate storage device on a communication network may access to a device implementing the embodiment of the disclosure.

In this disclosure, the term “computer program product” or “computer readable medium” is used for referring collectively to media such as a memory, hard disk installed in a hard disk drive, and signals. These “computer program products” or “computer readable recording media” are components provided in the method of reporting UE capabilities in the wireless communication system according to the disclosure.

A storage medium that may be read by a device may be provided in the form of a non-transitory storage medium. Here, a “non-transitory storage medium” only means that it is a tangible device and does not include signals (e.g., electromagnetic waves), and this term does not distinguish the case that data is semi-permanently stored in a storage medium and the case that data is stored temporarily in a storage medium. For example, a “non-transitory storage medium” may include a buffer where data is temporarily stored.

According to an embodiment, a method according to various embodiments disclosed in this document may be included and provided in a computer program product. Computer program products may be traded between sellers and buyers as commodities. The computer program product may be distributed in the form of a machine readable storage medium (e.g., compact disc read only memory (CD-ROM)), or via an application store (e.g., Play Store™) or may be distributed (e.g., download or upload) online or directly between two user devices (e.g., smartphones). In the case of online distribution, at least a part of the computer program product (e.g., downloadable app) may be at least temporarily stored or temporarily generated in a machine readable storage medium such as a memory of a server of a manufacturer, a server of an application store, or a relay server.

In the specific embodiments of the disclosure described above, components included in the disclosure are expressed in the singular or plural according to the presented specific embodiments. However, the singular or plural expression is appropriately selected for a situation presented for convenience of description, and the disclosure is not limited to the singular or plural components, and even if a component is represented in the plural, it may be composed of the singular, or even if a component is represented in the singular, it may be composed of the plural.

Embodiments of the disclosure disclosed in this specification and drawings merely present specific examples in order to easily describe the technical contents of the disclosure and help the understanding of the disclosure, and they are not intended to limit the scope of the disclosure. That is, it will be apparent to those of ordinary skill in the art to which the disclosure pertains that other modifications based on the technical spirit of the disclosure may be implemented. Further, each of the above embodiments may be operated in combination with each other, as needed. For example, a base station and a UE may be operated by combining parts of an embodiment of the disclosure and another embodiment. Further, the embodiments of the disclosure may be applied to other communication systems, and other modifications based on the technical idea of the embodiments may also be implemented. For example, embodiments may also be applied to an LTE system, 5G, NR system, or 6G system. Therefore, the scope of the disclosure should not be limited to the described embodiments and should be defined not only by the claims described below, but also by equivalents of these claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a network entity performing a location management function (LMF), pre-defined positioning reference signal (PRS) configuration information;
transmitting, to the network entity performing the LMF, a request for an on-demand PRS, wherein the request for the on-demand PRS includes periodicity information associated with a subcarrier spacing (SCS) of a synchronization signal block (SSB); and
as a response to the transmission of the request for the on-demand PRS, receiving, from the network entity performing the LMF, PRS configuration information.

2. The method of claim 1, wherein the periodicity information is for a requested periodicity of a downlink (DL)—PRS resource set, and
wherein the requested periodicity is associated with the SCS of the SSB of a current primary cell of the UE.

3. The method of claim 1, wherein the PRS configuration information is received via a long term evolution positioning protocol (LPP) provide assistance data message.

4. The method of claim 1, wherein the pre-defined positioning reference signal (PRS) configuration information is received via a long term evolution (LTE) positioning protocol (LPP) provide assistance data message, and
wherein the request for the on-demand PRS is transmitted via a LPP request assistance data message.

5. A method performed by a network entity in a communication system, the method comprising:
transmitting, to a user equipment (UE), pre-defined positioning reference signal (PRS) configuration information;
receiving, from the UE, a request for an on-demand PRS, wherein the request for the on-demand PRS includes periodicity information associated with a subcarrier spacing (SCS) of a synchronization signal block (SSB); and
as a response to the reception of the request for the on-demand PRS, determining a need for a PRS transmission or a change of an ongoing PRS transmission.

6. The method of claim 5, wherein the periodicity information is for a requested periodicity of a downlink (DL)—PRS resource set, and
wherein the requested periodicity is associated with the SCS of the SSB of a current primary cell of the UE.

7. The method of claim 5, the method further comprising:
based on the determination, transmitting, to the UE, PRS configuration information.

8. The method of claim 7, wherein the PRS configuration information is transmitted via a long term evolution positioning protocol (LPP) provide assistance data message.

9. The method of claim 5, wherein the pre-defined positioning reference signal (PRS) configuration information is transmitted via a long term evolution (LTE) positioning protocol (LPP) provide assistance data message, and
wherein the request for the on-demand PRS is received via a LPP request assistance data message.

10. The method of claim 5, the method further comprising:
transmitting, to at least one base station, a PRS configuration request message for a new PRS transmission or a change of the pre-defined PRS configuration information; and
receiving, from the at least one base station, a PRS configuration response message including PRS configuration information.

11. A user equipment (UE) in a communication system, the UE comprising:
a transceiver; and
a controller coupled with the transceiver, and configured to:
receive, from a network entity performing a location management function (LMF), pre-defined positioning reference signal (PRS) configuration information;
transmit, to the network entity performing the LMF, a request for an on-demand PRS, wherein the request for the on-demand PRS includes periodicity information associated with a subcarrier spacing (SCS) of a synchronization signal block (SSB); and
as a response to the transmission of the request for the on-demand PRS, receive, from the network entity performing the LMF, PRS configuration information.

12. The UE of claim 11, wherein the periodicity information is for a requested periodicity of a downlink (DL)—PRS resource set, and
wherein the requested periodicity is associated with the SCS of the SSB of a current primary cell of the UE.

13. The UE of claim 11, wherein the PRS configuration information is received via a long term evolution positioning protocol (LPP) provide assistance data message.

14. The UE of claim 11, wherein the pre-defined positioning reference signal (PRS) configuration information is received via a long term evolution (LTE) positioning protocol (LPP) provide assistance data message, and
wherein the request for the on-demand PRS is transmitted via a LPP request assistance data message.

15. A network entity in a communication system, the network entity comprising:
a transceiver; and
a controller coupled with the transceiver, and configured to:
transmit, to a user equipment (UE), pre-defined positioning reference signal (PRS) configuration information,
receive, from the UE, a request for an on-demand PRS, wherein the request for the on-demand PRS includes periodicity information associated with a subcarrier spacing (SCS) of a synchronization signal block (SSB), and
as a response to the reception of the request for the on-demand PRS, determine a need for a PRS transmission or a change of an ongoing PRS transmission.

16. The network entity of claim 15, wherein the periodicity information is for a requested periodicity of a downlink (DL)—PRS resource set, and
wherein the requested periodicity is associated with the SCS of the SSB of a current primary cell of the UE.

17. The network entity of claim 16, wherein the controller is further configured to:
based on the determination, transmit, to the UE, PRS configuration information.

18. The network entity of claim 15, wherein the PRS configuration information is transmitted via a long term evolution positioning protocol (LPP) provide assistance data message.

19. The network entity of claim 15, wherein the pre-defined positioning reference signal (PRS) configuration information is transmitted via a long term evolution (LTE) positioning protocol (LPP) provide assistance data message, and
wherein the request for the on-demand PRS is received via a LPP request assistance data message.

20. The network entity of claim 15, wherein the controller is further configured to:
transmit, to at least one base station, a PRS configuration request message for a new PRS transmission or a change of the pre-defined PRS configuration information, and
receive, from the at least one base station, a PRS configuration response message including PRS configuration information.
